(19) United States
(12) Patent Application Publication
(10) Pub. No.: US 2008/0091730 A1
(43) Pub. Date: Apr. 17, 2008

(54) Computational systems for biomedical data

(75) Inventors: Edward K.Y. Jung, Bellevue, WA (US); Royce A. Levien, Lexington, MA (US); Robert W. Lord, Seattle, WA (US); Lowell L. Wood JR., Bellevue, WA (US)

Correspondence Address: Searete LLC, Suite 110, 1756 - 114th Ave. S.E., Bellevue, WA, 98004, US

(73) Assignee: Searete LLC, a limited liability corporation of the State of Delaware

(21) Appl. No.: 11/881,803

(22) Filed: Jul. 26, 2007

Related U.S. Application Data
(63) Continuation-in-part of application No. 11/541,478, filed on Sep. 29, 2006.
(63) Continuation-in-part of application No. 11/728,311, filed on Mar. 22, 2007.

(51) Int. Cl. G06F 17/30

(52) U.S. Cl. 707/104.1; 707/E17.001; 707/E17.014

(57) ABSTRACT

Methods, apparatuses, computer program products, devices and systems are described that carry out accepting an input identifying at least one allergy, accessing data containing at least one innate determinant associated with the at least one allergy, and accessing data containing at least one acquired determinant associated with the at least one allergy; and presenting a signal related to ingestion-dependent allergy information associated with a defined level of the at least one allergy in response to accessing data containing at least one innate determinant associated with the at least one allergy, and accessing data containing at least one acquired determinant associated with the at least one allergy.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC § 119(e) for provisional patent applications, for any and all parent, grandparent, great-grandparent, etc. applications of the Related Application(s)).

### RELATED APPLICATIONS

For purposes of the USPTO extra-statutory requirements, the present application constitutes a continuation-in-part of U.S. patent application Ser. No. 11/541,478, entitled COMPUTATIONAL SYSTEMS FOR BIOMEDICAL DATA, naming Edward K. Y. Jung; Royce A. Levien; Robert W. Lord and Lowell L. Wood, Jr. as inventors, filed 29 Sep. 2006 which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/647,531, entitled COMPUTATIONAL SYSTEMS FOR BIOMEDICAL DATA, naming Edward K. Y. Jung; Royce A. Levien; Robert W. Lord and Lowell L. Wood, Jr. as inventors, filed 27 Dec. 2006 which is currently co-pending, or is an application of which a currently co-pending application is entitled to the benefit of the filing date.
For purposes of the USPTO extra-statutory requirements, the present application constitutes a continuation-in-part of U.S. patent application Ser. No. 11/647,533, entitled COMPUTATIONAL SYSTEMS FOR BIOMEDICAL DATA, naming Edward K. Y. Jung; Royce A. Levien; Robert W. Lord and Lowell L. Wood, Jr. as inventors, filed 27 Dec. 2006 which is currently co-pending, or is an application of which a currently co-pending application is entitled to the benefit of the filing date.

The United States Patent Office (USPTO) has published a notice to the effect that the USPTO's computer programs require that patent applicants reference both a serial number and indicate whether an application is a continuation or continuation-in-part. Stephen G. Kunin, Benefit of Prior-Filed Application, USPTO Official Gazette Mar. 18, 2003, available at http://www.uspto.gov/web/offices/com/sol/og/2003/week11/patbene.htm. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant is designating the present application as a continuation-in-part of its parent applications as set forth above, but expressly points out that such designations are not to be construed in any way as any type of commentary and/or admission as to whether or not the present application contains any new matter in addition to the matter of its parent application(s).

All subject matter of the Related Applications and of any and all parent, grandparent, great-grandparent, etc. applications of the Related Applications is incorporated herein by reference to the extent such subject matter is not inconsistent herewith.

### TECHNICAL FIELD

This description relates to data handling techniques.

### SUMMARY

An embodiment provides a method. In one implementation, the method includes but is not limited to accepting an input identifying at least one allergy; accessing data containing at least one innate determinant associated with the at least one allergy, and accessing data containing at least one acquired determinant associated with the at least one allergy; and presenting a signal related to ingestion-dependent allergy information associated with a defined level of the at least one allergy in response to accessing data containing at least one innate determinant associated with the at least one allergy, and accessing data containing at least one acquired determinant associated with the at least one allergy. In addition to the foregoing, other method aspects are described in the claims, drawings, and text forming a part of the present disclosure.

An embodiment provides a method. In one implementation, the method includes but is not limited to accepting an input identifying at least one ingested agent associated with an allergic reaction; accessing a dataset to identify at least one innate determinant of the allergic reaction in a population; identifying at least one test determinant of the allergic reaction in the population; determining, based on the innate and test determinants, at least one subpopulation for which the allergic reaction associated with administration of the at least one ingested agent is unacceptable within a defined limit relative to a population for which the allergic reaction associated with administration of the at least one agent is acceptable with respect to the defined limit; and presenting a signal related to the at least one subpopulation in response to determining, based on the innate and test determinants, the at least one subpopulation. In addition to the foregoing, other method aspects are described in the claims, drawings, and text forming a part of the present disclosure.

An embodiment provides a method. In one implementation, the method includes but is not limited to accepting an input identifying at least one allergy at one or more user interfaces; and transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy; and presenting a signal related to ingestion-dependent allergy information associated with a defined level of the at least one allergy in response to accessing data containing at least one innate determinant associated with the at least one allergy, and accessing data containing at least one acquired determinant associated with the at least one allergy; and the data analysis system further being capable of sending a signal to either the one or more user interfaces or a different user interface in response to the presenting a signal related to ingestion-dependent allergy information associated with a defined level of the at least one allergy, which signal transmits the ingestion-dependent allergy information. In addition to the foregoing, other method aspects are described in the claims, drawings, and text forming a part of the present disclosure.

In one or more various aspects, related systems include but are not limited to circuitry and/or programming for effecting the herein-referenced method aspects; the circuitry and/or programming can be virtually any combination of hardware, software, and/or firmware configured to effect the herein-referenced method aspects depending upon the design choices of the system designer.

An embodiment provides a system. In one implementation, the system includes but is not limited to means for accepting an input identifying at least one allergy, means for accessing data containing at least one innate determinant associated with the at least one allergy, and means for accessing data containing at least one acquired determinant associated with the at least one allergy, and means for presenting a signal related to ingestion-dependent allergy information associated with a defined level of the at least one allergy in response to data containing at least one innate determinant associated with the at least one allergy and data containing at least one acquired determinant associated with the at least one allergy. In addition to the foregoing, other system aspects are described in the claims, drawings, and text forming a part of the present disclosure.

An embodiment provides a system. In one implementation, the system includes but is not limited to means for accepting an input identifying at least one ingested agent associated with an allergic reaction; means for accessing a dataset to identify at least one innate determinant of the allergic reaction in a population; means for identifying at least one test determinant of the allergic reaction in the population; means for determining, based on the innate and test determinants, at least one subpopulation for which the allergic reaction associated with administration of the at least one ingested agent is unacceptable within a defined limit relative to a population for which the allergic reaction associated with administration of the at least one agent is acceptable with respect to the defined limit; and means for presenting a signal related to the at least one subpopulation in response to the at least one subpopulation. In addition to the foregoing, other system aspects are described in the claims, drawings, and text forming a part of the present disclosure.

An embodiment provides a system. In one implementation, the system includes but is not limited to means for accepting an input identifying at least one allergy at one or more user interfaces; and means for transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy; presenting a signal related to ingestion-dependent allergy information associated with a defined level of the at least one allergy in response to accessing data containing at least one innate determinant associated with the at least one allergy, and accessing data containing at least one acquired determinant associated with the at least one allergy; and the data analysis system further being capable of sending a signal to either the one or more user interfaces or a different user interface in response to presenting a signal related to ingestion-dependent allergy information associated with a defined level of the at least one allergy, which signal transmits the ingestion-dependent allergy information. In addition to the foregoing, other system aspects are described in the claims, drawings, and text forming a part of the present disclosure.

An embodiment provides a computer program product. In one implementation, the system includes but is not limited to a signal-bearing medium bearing (a) one or more instructions for accepting an input identifying at least one allergy; (b) one or more instructions for accessing data containing at least one innate determinant associated with the at least one allergy, and accessing data containing at least one acquired determinant associated with the at least one allergy; and (c) one or more instructions for presenting a signal related to ingestion-dependent allergy information associated with a defined level of the at least one allergy in response to accessing data containing at least one innate determinant associated with the at least one allergy, and accessing data containing at least one acquired determinant associated with the at least one allergy. In addition to the foregoing, other computer program product aspects are described in the claims, drawings, and text forming a part of the present disclosure.

An embodiment provides a system. In one implementation, the system includes but is not limited to a computing device and instructions. The instructions when executed on the computing device cause the computing device to (a) accept an input identifying at least one allergy; (b) access data containing at least one innate determinant associated with the at least one allergy, and access data containing at least one acquired determinant associated with the at least one allergy; and (c) present a signal related to ingestion-dependent allergy information associated with a defined level of the at least one allergy in response to accessing data containing at least one innate determinant and at least one acquired determinant sharing an association with the at least one allergy. In addition to the foregoing, other system aspects are described in the claims, drawings, and text forming a part of the present disclosure.

In one or more various aspects, related systems include but are not limited to computing means and/or programming for effecting the herein-referenced method aspects; the computing means and/or programming may be virtually any combination of hardware, software, and/or firmware configured to effect the herein-referenced method aspects depending upon the design choices of the system designer.

In addition to the foregoing, various other method and/or system and/or program product aspects are set forth and described in the teachings such as text (e.g., claims and/or detailed description) and/or drawings of the present disclosure.

The foregoing is a summary and thus contains, by necessity, simplifications, generalizations and omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE DRAWINGS

With reference now to FIG. 1, shown is an example of a data analysis system in which embodiments may be implemented, perhaps in a device, which may serve as a context for introducing one or more processes and/or devices described herein.

FIG. 2 illustrates certain alternative embodiments of the data analysis system of FIG. 1.

FIG. 3 illustrates an embodiment of study data associated with the data analysis system of FIG. 1.

FIG. 4 illustrates alternative embodiment of study data associated with the data analysis system of FIG. 1.

FIG. 5 illustrates another alternative embodiment of study data associated with the data analysis system of FIG. 1, with specific examples of study data.

FIG. 6 illustrates additional alternative embodiments of study data associated with the data analysis system of FIG. 1, with specific examples of study data.

FIG. 7 illustrates additional alternative embodiments of study data associated with the data analysis system of FIG. 1, with specific examples of study data.

FIG. 8 illustrates additional alternative embodiments of study data associated with the data analysis system of FIG. 1, with specific examples of study data.

With reference now to FIG. 9, shown is an example of an operational flow representing example operations related to computational systems for biomedical data, which may serve as a context for introducing one or more processes and/or devices described herein.

FIG. 10 illustrates an alternative embodiment of the example operational flow of FIG. 9.

FIG. 11 illustrates an alternative embodiment of the example operational flow of FIG. 9.

FIG. 12 illustrates an alternative embodiment of the example operational flow of FIG. 9.

FIG. 13 illustrates an alternative embodiment of the example operational flow of FIG. 9.

FIG. 14 illustrates an alternative embodiment of the example operational flow of FIG. 9.

FIG. 15 illustrates an alternative embodiment of the example operational flow of FIG. 9.

FIG. 16 illustrates an alternative embodiment of the example operational flow of FIG. 9.

FIG. 17 illustrates an alternative embodiment of the example operational flow of FIG. 9.

FIG. 18 illustrates an alternative embodiment of the example operational flow of FIG. 9.

With reference now to FIG. 19, shown is an example of an operational flow representing example operations related to computational systems for biomedical data, which may serve as a context for introducing one or more processes and/or devices described herein.

With reference now to FIG. 20, shown is an example of an operational flow representing example operations related to computational systems for biomedical data, which may serve as a context for introducing one or more processes and/or devices described herein.

With reference now to FIG. 21, shown is a partial view of an example computer program product that includes a computer program for executing a computer process on a computing device related to computational systems for biomedical data, which may serve as a context for introducing one or more processes and/or devices described herein.

With reference now to FIG. 22, shown is an example device in which embodiments may be implemented related to computational systems for biomedical data, which may serve as a context for introducing one or more processes and/or devices described herein.

The use of the same symbols in different drawings typically indicates similar or identical items.

### DETAILED DESCRIPTION

FIG. 1 illustrates an example research system 100 in which embodiments may be implemented. The research system 100 includes an allergy data analysis system 102. The allergy data analysis system 102 may be used, for example, to store, recall, access, implement, or otherwise use datasets or other information obtained from study data 106.

The allergy data analysis system 102 may be used, for example, to determine allergy susceptibility in a population, including an individual, for a given allergy by analyzing innate (e.g., genetic) determinants and acquired (e.g., environmental) determinants that together are associated with a defined level of the allergy. The allergy data analysis system 102 may determine such susceptibility by, for example, storing, analyzing and/or providing information obtained from study data 106 as to the associations between allergy determinants and levels of allergy symptoms.

An allergy is typically an immune-mediated hypersensitivity to things in the environment. Allergies can cause, for example, skin irritation, respiratory distress, or, in extreme cases, anaphylactic shock, and death. Examples of allergies include peanut allergy, pollen allergy, and asthma. Allergies are among the most common causes of chronic health problems in industrialized countries, affecting up to one third of the general population.

The Gell and Coombs classification divides allergies into four patliophysiological types, namely immediate (Type I, including anaphylaxis), antibody-mediated cytotoxic reactions (Type II), immune complex-mediated reactions (Type III), and delayed type hypersensitivity (Type IV). Although this classification was proposed more than 30 years ago, it is still widely used. There are, however, hypersensitivities that do not fit within the Gell and Coombs classification; at least three different situations can be identified in this vein, namely pseudo-allergic reactions, primarily antibody-mediated reactions and cell-mediated reactions, all of which are considered to be allergies as that term is used herein. Other hypersensitivies not included within the Gell and Coombs Type I-IV are to be considered allergies as that term is used herein. Similarly, the term “allergen,” discussed below, includes agents that cause both Gell and Coombs Type I, II, III, and/or IV reactions, and/or other hypersensitivities.

Atopy defines a general predisposition to develop allergic reactions to otherwise innocuous substances. Atopic individuals may have serum IgE levels that are up to one-thousand fold higher than that of a normal individual.

Allergies are thought to be caused by environmental exposure to allergens. An allergen is any substance that is recognized by the immune system and causes an allergic reaction. Many allergen databases exist and are accessible to the public. Such databases include, for example, the web-based Structural Database of Allergenic Proteins (SDAP) permits the user to quickly compare the sequence and structure of allergenic proteins. Data from literature sources and previously existing lists of allergens are combined in a MySQL interactive database with a wide selection of bioinformatics applications. SDAP is available on the web at http://fermi.utmb.edu/SDAP/index.html.

Further, The International Union of Immunological Societies (IUIS) has published a list of allergens by source, taxonomic order, allergen name, isoallergen name (if present), common name, biochemical name, obsolete name, molecular weight by SDS-PAGE analysis, allergen allergenicity, allergen allergenicity literature reference, reference and/or accession number(s), isoallergen allergenicity (if present), isoallergen allergenicity reference (if present), amino acid sequence, amino acid sequence reference, and sequence features. This list is updated annually and is available on the web at http://www.allergen.org/Allergen.aspx. Alternatively, the list is downloadable at the administration page of http://www.allergen.org/Allergen.aspx at the link “Download Excel readable version: ExportReadable.xis” on that page.

Examples of known allergens include foreign proteins found in foreign serum from blood transfusions and vaccines, plant pollens (e.g., hay fever, rye grass, ragweed, timothy grass, and birch trees), mold spores, fungus, drugs (e.g., antibiotics, sulfonamides, salicylates (also found naturally in numerous fruits), NSAIDS, beta blockers, chemotherapeutics, anti-convulsants, and anesthetics), foods (e.g., nuts, sesame, seafood, egg (typically albumin, the egg white), peas, beans, peanuts, soybeans and other legumes, soy, milk, wheat, and corn), insect stings (e.g., bee sting venom, and wasp sting venom), animal products (e.g., animal hair and dander (e.g., dog, cat, horse, rabbit, hamster, guinea pig, gerbil, or bird), cockroach calyx, and dust mite excretion), chemicals (e.g., thimerosol, formaldehyde, phenol, sulfite, glycerin, hydrocarbon, pesticide, metal, fertilizer, or airborne pollutants), and latex.

Allergy diagnosis is a crucial step in avoiding allergy problems. Allergies may develop in infants within a very short time after birth. For example, peanut allergy may be induced in an infant through the mother's diet during gestation or nursing. Current allergy diagnosis involves tests for immunoglobulin E (IgE), the antibody that is responsible for the allergic reaction. Such tests may measure total IgE levels and/or levels of IgE that recognize a specific allergen (specific IgE). Other allergy diagnostic tests involve skin tests using the allergen to elicit a skin reaction in allergic subjects.

One problem with current allergy diagnostic methods is a relatively poor clinical specificity; i.e., both positive in vitro IgE tests and positive skin tests are common in sensitized subjects who are asymptomatic. These false positives are common in food allergy cases, for example, where another diagnostic test, the food challenge, is sometimes used. Food challenges can be performed either in an open protocol or by double blind challenge. The gold standard for food allergy diagnosis is the double blind placebo-controlled food challenge. These studies are undertaken in a hospital where the patient receives a series of capsules or liquid containing either the food or placebo. Short-term elimination diets (2-3 weeks) can be helpful in some subjects. It is important that the food is totally eliminated as exposure to even small amounts of the food protein may lead to eczema. In the case of infants being breastfed, the mother may also need to eliminate the food from her diet. Some maternal food proteins have been shown to cross into breast milk.

One common IgE test is the RAST test (short for radioallergosorbent test). The RAST test, using a person's extracted blood, detects the amount of IgE that reacts specifically with suspected or known allergens. If a person exhibits a high level of IgE directed against pollen, the test may indicate the person is allergic to, e.g., pollen (or pollen-like) proteins. However, a person who has outgrown an allergy may still have a positive IgE test years after exposure. Many subjects with eczema have very high levels of total IgE; low-level false positive results may be seen in these cases because there is so much IgE present in the blood sample that it shows up as a positive result for allergens that the person is not allergic to. Similarly, allergens with similar protein structures may cross-react, resulting in false positive results. Also, the level of positivity of the test generally is not indicative of the degree of allergy present.

Commonly, diagnosis of food allergy relies on a significant clinical history of allergy symptoms plus evidence of specific IgE to the food allergen in question. The absence of a specific IgE to a food means that there is a 95% probability that the ingestion of the food will not lead to clinical symptoms. The presence of specific IgE to a particular food, however, has only at best a 50% positive predictive value when correlated with a positive food challenge.

Currently, two types of tests can help predict whether someone will have an allergic reaction to future bee stings. Neither test is perfect. Skin testing results correlate best with the magnitude of subsequent allergic reactions. Still, up to 46% of nonallergic individuals have positive skin tests and up to 25% of allergic individuals have negative skin tests.

Skin tests also are imperfect; some studies have shown that only ⅓ of positive food skin tests could be confirmed by a double blind food challenge. Other studies have shown that up to 46% of nonallergic individuals have positive skin tests. In addition, eliminating all foods to which the patient reacts to on skin testing may lead to nutritional problems.

As a result of such problems with current tests, improved diagnosis is needed. Recent studies have focused on biochemical events that are proximate to IgE recognition of allergens, such as histamine release by mast cells, as environmental markers for allergy. For example, Asero et al. have evaluated the potential of biological in vitro tests such as histamine release tests or basophil activation tests including assays performed with permanently growing cell lines (Asero et al., Mol. Nutr. Food Res., 51(1), pp. 135-147 (2006).

Beyond this, some groups have investigated possible genetic predictors of allergy. For example, it has been shown that the frequencies of two polymorphisms of the RANTES (a human chemokine) promoter region are significantly higher in subjects with allergic rhinitis than in control subjects. Others have looked at associations of human leukocyte antigen (HLA) gene polymorphisms with allergy. Twin studies have shown heritability estimates for eczema of 60% and it appears that a predisposition to atopic allergy may be heritable, although the specific form of allergy is generally not predictable based on a family history of atopy. Indeed, no genetic markers have been identified that can reliably predict specific allergy susceptibility.

An innate determinant, as used herein, may be, for example, a genetic sequence, including, for example, a single nucleotide polymorphism, haplotypes, and/or other gene sequence information. An innate determinant may also be, for example, gene expression (e.g., mRNA expression information or protein expression information). An innate determinant may also be, for example, epigenetic information (e.g., DNA methylation, histone methylation, histone acetylation, histone phosphorylation, histone sumoylation, histone ubiquitylation/ADP-ribosylation, or regulatory short interfering RNA information), biochemical information such as liver cytochrome enzyme phenotype information, or cell population information. Alternatively, total IgE levels that are not associated with an allergy (e.g., an individual's normal, pre-exposure total IgE levels) may be the innate determinant. An innate allergy determinant may be an innate determinant that has an association with an allergy.

For example, changes in histone acetylation at the IL-4 and IFN-γ loci ave been implicated in allergy susceptibility. (See Bousquet et al., “Epigenetic inheritance of fetal genes in allergic asthma,” Allergy, vol. 59(2), pp. 138-147 (2004), which is incorporated by reference herein in its entirety).

An acquired determinant, as used herein, may be, for example, environmental exposure information or immunologic measures that reflect environmental exposure information. For example, a measure of total IgE associated with the allergy may be the acquired determinant, or a measure of specific IgE may be the acquired determinant. Alternatively, for example, dietary, nutraceutical, or medical regimen information may be the acquired determinant. An acquired allergy determinant may be an acquired determinant that has an association with an allergy.

Allergy information, including ingestion-dependent allergy information, may be, for example, a combination of innate and acquired allergy determinants together with associated allergy symptoms. Such allergy information may be reported in, for example, allergy studies. Allergy information provides an improved marker for groups of people that experience defined levels of allergy. As one example, an innate allergy determinant and an acquired allergy determinant may be employed as covariates in a regression equation to determine allergy risk for individuals or populations having each determinant to some degree.

An agent, as used herein, may be, for example, a medical or non-medical intervention, including, for example, administration of prescription or non-prescription medications, small molecule drugs or biologics, nutraceuticals, or dietary supplements. An agent may also be, for example, alcohol or an illicit substance. An agent may be a prodrug or a metabolite of a compound.

As a further example, the allergy data analysis system 102 may, for a given agent associated with an allergic reaction, provide information about subpopulations for which the allergic reaction is acceptable or unacceptable within a defined limit relative to a general population. Identification of such subpopulations can provide avenues for agent testing and development according to defined levels of tolerance, for an allergic reaction to an agent. On the basis of study data analysis, for example, for a given agent associated with an allergic reaction, a subpopulation exhibiting a specific level of allergy may be identified by accessing a dataset to identify at least one innate determinant of the allergic reaction in a population and to identify at least one allergy test determinant (e.g., IgE test result, skin test result, food challenge test result, etc.) of the allergic reaction in a population. Thus, identified subpopulations exhibit acceptable (or unacceptable, as specified) levels of allergy symptoms.

In FIG. 1, the allergy data analysis system 102 is used by a researcher 104. The researcher 104, for example, may use the allergy data analysis system 102 to enter, store, request, or access study data relating to innate allergy determinants, acquired or test determinants, and/or subject medical history data, such as, for example, the various examples provided herein. The researcher 104 may generally represent, for example, a person involved in health care or the health care industry, including, for example, a pharmaceutical company researcher or clinician, a biotechnology company researcher or clinician, a doctor, or a biomedical researcher. The researcher 104 also may represent someone who is involved in health care in the sense of developing, managing, or implementing the allergy data analysis system 102, e.g., a software developer with clinical knowledge (or access to clinical knowledge), a database manager, or an information technologies specialist. The researcher 104 also may represent a nutraceutical or cosmetics researcher. Even more generally, some or all of various functions or aspects described herein with respect to the researcher 104 may be performed automatically, e.g., by an appropriately-designed and implemented computing device, or by software agents or other automated techniques.

Study data 106 is typically data relating to allergen, conditions of allergen ingestion or contact, allergy, allergy symptoms, subject attributes including genetic, gene expression, and biochemical characteristics, subject attributes including IgE levels, cell or enzyme phenotypes, subject medical history, allergy test data, statistical parameters and outcomes, and/or other experimental conditions or results. Study data 106 also may represent or include diagnostic testing, for example, to determine the effect of administration of an agent, such as a medication, on total or specific IgE levels.

Study data 106 may originate from, for example, an experiment and may be found in one or more different sources, including, for example, published journal articles, clinical trial reports including medical history data, data reported on internet site(s), data submitted to the Food and Drug Administration or other regulatory agency, data included in allergy and/or pharmacogenomic database(s), data included in genetic database(s), or data found in other relevant database(s) that contain data relating to allergic reactions to allergens, including the conditions of use, effect, mechanism of action or other properties of an allergen that are relevant to a subject. Study data 106 may also originate from a mathematical and/or computer simulation(s) of one or more properties of an agent, for example, data from an in vitro/in vivo correlation analysis. Study data 106, for example, could result from pre-clinical testing or clinical testing, and may include data from in vitro testing, in situ testing, in vivo testing in animals or clinical testing in human subjects. A formal clinical trial is one example of a study that results in study data 106.

Study data 106 may include raw data, for example, allergen or agent name, allergen concentration, allergen concentration in the blood at various times, and/or reported allergy symptoms experienced by study participants.

Study data 106 may also include study participant data or other information such as, for example, age, weight, gender, race, ethnicity, dietary factors, behavioral factors, medical history, concomitant medications, and other demographic characteristics. Study data 106 may also include molecular information about study participants such as, for example, genomic DNA sequence, cDNA sequence, single nucleotide polymorphisms (SNP's), haplotype profile, insertion and/or deletion (INDEL) profile, restriction fragment length polymorphism (RFLP) profile, chromatin state, nucleosome and/or histone/nucleoprotein composition, RNA sequence, micro RNA sequence, pyknon sequence and/or profile, RNA expression levels, protein sequence, protein expression levels, cytokine levels and/or activity, circulating hormone levels and/or activity, circulating carbohydrate levels, neurotransmitter levels, nitric oxide levels, liver enzyme expression and/or activity, gastrointestinal enzyme expression and/or activity, renal enzyme expression and/or activity, and/or other biochemical markers.

Study data 106 may include data points that are, for example, ordinals (e.g., 1^{st}, 2^{nd}, 3^{rd}), nominals (e.g., itching, burning), binaries (e.g., alive/dead), genetic (e.g., AGCGGAATTCA), and/or continuous (e.g., 1-4, 5-10).

As a further example, the allergy data analysis system 102 (including allergy data association logic 126 and/or allergy information association logic 128) may accept an input identifying at least one allergy; access data containing at least one innate determinant associated with the at least one allergy; access data containing at least one acquired determinant associated with the at least one allergy; and present a signal related to ingestion-dependent allergy information associated with a defined level of the at least one allergy in response to accessing data containing at least one innate determinant associated with the at least one allergy, and accessing data containing at least one acquired determinant associated with the at least one allergy. A query parameter, for example, may be used to specify the defined level of allergy that serves to limit the study data 106 to a specific set of innate and acquired allergy determinants associated with, for example, a specific incidence of a peanut allergy symptom. Study data 106 may report allergy levels, however it is understood that such reported data may or may not precisely match actual allergy levels.

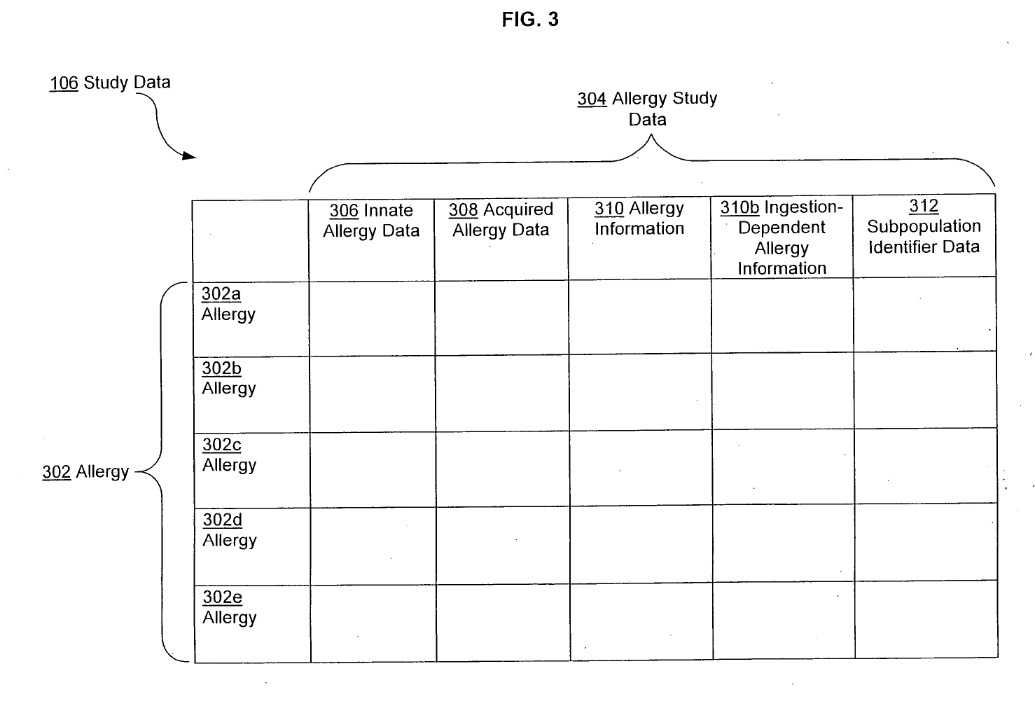

The allergy data analysis system 102 also may associate the innate and acquired allergy determinants associated with allergy symptoms (e.g., allergy information) with subpopulation identifier data to identify one or more relevant patient populations. For example, innate and acquired allergy determinants may be identified using the allergy data analysis system 102, which determinants are associated with tolerable allergy levels in allergic or non-allergic individuals exposed to allergen. The allergy data analysis system 102 may then be used to further search, for example, one or more population databases to find subpopulation identifier data 312 (FIG. 3) that associate the innate and/or acquired determinants with one or more relevant patient populations. Such population databases may include, for example, those that contain molecular information about individuals or populations such as, for example, genomic DNA sequence, cDNA sequence, single nucleotide polymorphisms (SNP's), haplotype profile, insertion and/or deletion (INDEL) profile, restriction fragment length polymorphism (RFLP) profile, chromatin state, nucleosome and/or histone/nucleoprotein composition, RNA sequence, micro RNA sequence, pyknon sequence and/or profile, RNA expression levels, protein sequence, protein expression levels, cytokine levels and/or activity, circulating hormone levels and/or activity, circulating carbohydrate levels, neurotransmitter levels, nitric oxide levels, liver enzyme expression and/or activity, gastrointestinal enzyme expression and/or activity, renal enzyme expression and/or activity, and/or other biochemical markers.

Ongoing, prospective and completed clinical trials for various allergies and agents may be found in databases such as http://www.clinicaltrials.gov, which lists specific details for clinical trials, including primary and secondary outcomes, enrollment size, inclusion and exclusion criteria, patient profiles, and other parameters. In addition, clinical trial results, including allergy trials, are generally available in journal publications that are known to, and accessible by, persons of ordinary skill in the art.

The allergy data analysis system 102 (including allergy data association logic 126 and/or allergy information association logic 128) may apply appropriate statistical methods to study data 106, which may provide, for example, an average value(s) for a set of data, a confidence level(s) for a confidence interval(s), p-value(s), or other measures of statistical significance for multiple data points in one or more datasets, such as observed or simulated study data 106. Such statistical methods may comprise a query parameter that defines the level of the at least one allergy. For example, the allergy data analysis system 102 may include allergy data association logic 126 and/or allergy information association logic 128 that is capable of applying a query parameter or statistical parameter to study data 106 as a means of identifying data and/or statistically significant data relevant to the association between allergy determinants (e.g., innate and/or acquired) and allergy symptoms, or between allergy information (including ingestion-dependent allergy information) and a subpopulation.

Study data 106 relating to (1) associations of innate determinants with allergies; (2) associations of acquired determinants with allergies; (3) associations of allergy determinants with defined levels of allergies; and (4) associations of allergy determinants and/or allergy information with subpopulation identifier data often are associated with a statistical measure of significance in terms of, for example, a statistical measure of association. For example, a particular HLA DNA sequence may be associated with an allergy predisposition to an extent that is statistically significant when compared to other HLA sequences. Further, the particular HLA DNA sequence accompanied by a certain level of total IgE in allergy patients may result in a statistically significant higher incidence of an allergy than is observed in populations having the particular HLA DNA sequence alone or the certain level of total IgE alone. Such combined innate and acquired allergy determinant data may have predictive effects for allergy susceptibility that are additive or even synergistic. Specificity of any association should be enhanced relative to analysis of innate or acquired allergy determinants alone, leading to fewer false positive and false negative allergy test results.

Statistical analysis may be classified into two main groups: hypothesis testing and estimation. In hypothesis testing, a study typically compares the occurrence of one or more endpoints in two or more groups of participants. This often involves a comparison of the mean, proportion, or other data parameter of, for example, allergy study data 304 (FIG. 3) in a test group to the same allergy study data 304 (FIG. 3) in a control group. Allergy study data 304 (FIG. 3), for example, may include measures such as mean levels of allergy symptoms associated with an innate and/or acquired allergy determinant. Allergy symptoms, for example, may include measures such as the mean incidence of anaphylaxis, or the proportion of subjects who experience breathing difficulty upon exposure to an allergen or other allergy trigger.

In estimation, the goal is to determine the relative value of a characteristic of interest in a group under study. The estimated value is usually accompanied by a statement about its certainty, or confidence interval, which is commonly expressed as a percentage. Estimation is important in hypothesis testing and in the analysis of safety variables. For example, in a study of a new antibiotic medication, the sponsor may be interested in estimating the proportion of patients that might experience a particular adverse event, including allergy symptoms. To ensure that the estimate has a high probability of being accurate, the allergy data analysis system 102 may determine the confidence interval for the estimate.

In the evaluation of study data, from whatever source, the character of the data is informative in terms of determining appropriate statistical measures to use to identify significant relationships and effects. The character of the data includes, for example, (1) the nature of the distribution of the primary, secondary, and influencing variables; (2) normal (Gaussian) or other well-known distributions; (3) if the data are not normally distributed, can they be changed by a function (e.g., a transformation) that preserves their order, but brings them into conformity with well-known assumptions about their distribution; (4) large enough sample size such that normality of the means can be assumed even if the data are not normally distributed; and/or (5) equality of variances of subgroups to be compared. These characteristics may be ascertained by applying common tests or by using basic data plots such as histograms or box plots. Knowing these characteristics of the data allows the allergy data analysis system 102 to validate the assumptions that underlie the data, and to select the most appropriate analytical method consistent with the data.

Study data 106 may, for example, contain two types of variables, quantitative and/or qualitative. Quantitative variables are numbers that may have, for example, a value within some acceptable range. For example, a person's blood pressure could be 120/80. Qualitative variables, however, typically lie within discrete classes, and are often characterized numerically by whole numbers. For instance, a subject who experiences nausea after agent administration could be characterized by a one, and a subject that does not could be classified as a zero. Qualitative variables may also be characterized by words.

The distribution of variables in a sample is important in determining what method of statistical analysis can be used. Normal, or Gaussian, distribution resembles the symmetrical bell-shaped curve by which most students are graded throughout their scholastic careers. It is typically characterized by two features: the mean, which is a measure of the location of the distribution, and the variance, which is a measure of the spread of the distribution. Many well-known statistical methods for analyzing means, such as the t-test or the paired t-test, rely on a normal distribution to ensure that the mean represents a measure of the center of the distribution.

Because statistical theory holds that the means of large samples are approximately normally distributed, an assumption of normality becomes less important as sample sizes increase. However, when sample sizes are small, it is important to determine whether the data to be analyzed are consistent with a normal distribution or with another well-characterized distribution.

Most common statistical tests of quantitative variables, including the t-tests and analysis of variance (ANOVA), are tests of the equality of the measures of location belonging to two or more subgroups that are assumed to have equal variance. A measure of location, such as a mean or median, is a single number that best describes the placement of the distribution (usually its center) on a number line. Because equal variance provides the basis of most tests that involve measures of location, in such cases an assumption of equal variance is more important than an assumption of normality, even when the tests do not rely on a specific distribution of the data (i.e., nonparametric tests). If the variances are not equal among the subgroups being compared, it is frequently possible to find a formula or function (e.g., a transformation) that preserves order and results in variables that do have equal variance.

When considering the distribution of data, it is also useful to look at a picture of them. The allergy data analysis system 102 may plot data to determine whether the distribution is shifted toward higher or lower values (skewed). The presence of one or more values that are much higher or lower than the main body of data indicates possible outliers. Data plots can also help to locate other data peculiarities. Common, statistically sound adjustment methods known to those of skill in the art may be used to correct many types of data problems.

Once the character of the variables of interest has been established, the allergy data analysis system 102 can test for comparability between, for example, allergy and non-allergy control groups. Comparability is established by performing statistical tests to compare, for example, demographic factors, such as age at the time of the study, age at the time of allergy onset, nationality, economic status, migration status, and/or gender; or prognostic factors measured at baseline, such as allergy severity, concomitant medication, or prior therapies. Biased results can occur when the comparison groups show discrepancies or imbalances in variables that are known or suspected to affect primary or secondary outcome measures. For instance, when a group includes a large proportion of participants whose disease is less advanced than in those of a comparison group, the final statistical analysis will often show a more significant effect for the patients whose disease is less advanced, even though the effect may not be primarily caused by an administered agent.

For example, in a trial comparing the effectiveness of surgery and iodine-131 for treatment of hyperthyroidism, researchers found that, surprisingly, patients who received the allegedly less-traumatic radiation therapy had a much higher frequency of illness and death than those who underwent surgery. Examination of the baseline characteristics of the two groups revealed that the patients selected for the surgery group were generally younger and in better health than those selected for the iodine treatment. The inclusion criteria for the surgery group were more stringent than those for the iodine group because the patients had to be able to survive the surgery.

It is desirable to perform comparability tests using as many demographic or prognostic variables simultaneously as the method of analysis will allow. The reason for using this approach is that the influence of a single, for example, demographic or prognostic characteristic on an outcome variable may be strongly amplified or diminished by the simultaneous consideration of a second characteristic. However, the size of many clinical trials is often insufficient to allow the simultaneous consideration of more than two variables. More commonly, the sample size of the study will allow consideration of only one variable at a time.

Imbalances detected in comparability testing do not necessarily invalidate study results. By tracking such differences, however, the allergy data analysis system 102 can account for their presence when comparing study data from allergy and control groups. Many statistical procedures may be used to adjust for imbalances either before or during an analysis, but such adjustments should be limited to cases where the extent of the difference is relatively small, as judged by a person of ordinary skill in the art.

Methods used for comprehensive analysis of study data vary according to the nature of the data, but also according to whether the analysis focuses on the effectiveness or the safety of the allergen or agent. Selection of an appropriate statistical method should also take into account the nature of the allergen or agent under study. For example, in vitro diagnostic studies may use statistical techniques that are somewhat specialized. Often the analysis is based on a specimen, such as a vial of blood, collected from a patient. The same specimen is typically analyzed by two or more laboratory methods to detect an analyte that is related to the presence of an allergy, condition or disease. Thus, each specimen results in a pair of measurements that are related to one another. The statistical treatment of such related (or associated) data is very different from that of unrelated (or un-associated) data because both measurements are attempting to measure exactly the same thing in the same individual. Generally, if both laboratory measurements result in a quantitative variable, a first statistical analysis will attempt to measure the degree of relationship between the measurements. The usual practice is to perform a simple linear regression analysis that assumes that the pairs of values resulting from the laboratory tests are related in a linear way.

In linear regression analysis, a best-fit line through the data is found statistically, and the slope is tested to determine whether it is statistically different from zero. A finding that the slope differs from zero indicates that the two variables are related, in which case the correlation coefficient, a measure of the closeness of the points to the best-fit line, becomes important. A correlation coefficient with a high value, either positive or negative, indicates a strong linear relationship between the two variables being compared. However, this correlation is an imperfect measure of the degree of relationship between the two measurements. That is, although a good correlation with a coefficient near one may not indicate good agreement between the two measurements, a low correlation is almost surely indicative of poor agreement.

Although correlation can indicate whether there is a linear relationship between two study measurements, it does not provide good information concerning their degree of equivalence. Perfect equivalence would be shown if the correlation were very near one, the slope very near one, and the intercept very near zero. It is possible to have a very good relationship between the two measures, but still have a slope that is statistically very different from one and an intercept that is very different from zero. In such a situation, one of the two measurements may be biased relative to the other.

Another relevant analysis of study data is a relative risk assessment or a receiver operating characteristic (ROC) analysis. Software is available to perform either of these analyses. A relative risk assessment is a ratio of the risk of a condition among patients with a positive test value to the risk of the condition among patients with a negative test value. The relative risk analysis can be done by use of either a logistic regression or a Cox regression depending on whether the patients have constant or variable follow-up, respectively. ROC analysis provides a measure of the robustness of the cutoff value as a function of sensitivity and specificity.

Analysis of the effectiveness and/or safety of an agent typically involves hypothesis testing to determine whether the agent maintains or improves the health of patients in a safe way. In some cases, a particular agent may be compared to an agent of known function. In such cases, the result will be a test of the hypothesis that the unknown agent is better than or equal to the known agent. Selection of an appropriate statistical method for analysis of data from such studies depends on the answers to many questions, such as (1) is the primary variable quantitative or qualitative; (2) was the primary variable measured only once or on several occasions; (3) what other variables could affect the measurement under evaluation; and (4) are those other variables qualitative (ordered or not) or quantitative?

If the primary variable under evaluation is quantitative, selection of an appropriate method of analysis will depend on how many times that variable was measured and on the nature of any other variables that need to be considered. If there is only a single measurement for each variable, and there are no differences among the potential covariates belonging to the treated and control groups, the appropriate method of analysis may be a parametric or nonparametric ANOVA or t-test. For example, a safety study of a new antibiotic for allergic reaction incidence in healthy subjects, with all other things being equal, could compare 30 day allergy rates of incidence by this method.

The choice of an appropriate analytical method changes if the covariates belonging to the two comparison groups differ and are measured qualitatively. Such cases may use a more complex analysis of variance or an analysis of covariance (ANCOVA). The ANCOVA method is particularly suited to analyzing variables that are measured before and after treatment, assuming that the two measurements are related in a linear or approximately linear manner. Using ANCOVA, the researcher first adjusts the post-treatment measure for its relationship with the pre-treatment measure, and then performs an analysis of variance. Using the example of the antibiotic, ANCOVA would be a suitable method of analysis if the amount of allergic reaction incidence in subjects receiving the antibiotic depended, for example, on the patients' pre-treatment level of total IgE.

Outcome variables are often measured more than once for each study subject. When this is done, it should be done in a balanced way such that when a variable is measured it is measured for every subject. A balanced-repeated-measures ANOVA can be performed with or without covariates. With covariates, this method reveals the effect of each subject's covariate value on the outcome variable, the effect of time for each patient, and whether the effect of time for each patient is changed by different values of the covariate. Continuing with the antibiotic example, a repeated-measures ANOVA could be applied to evaluate measurements of allergy symptoms before antibiotic administration and at 3′, 6, 9, and 12 days after initiation of dosing, and total IgE levels higher than, for example, 1000 ng/ml. In this case, the primary outcome variable is the level of allergy symptoms experienced, and the covariate is total IgE levels higher than 1000 ng/ml.

A repeated-measures ANOVA also may be used if a few patients missed a small number of measurements. However, in doing so the allergy data analysis system 102 may use other statistical algorithms known in the art in order to estimate the missing outcome measures.

Some studies result in a quantitative outcome variable and one or more quantitative covariates. In this situation, multiple regression methods are useful in evaluating outcome variables (called dependent variables), especially if the study involves several levels or doses of exposure as well as other factors (independent variables). Regression is a powerful analytical technique that enables the allergy data analysis system 102 to simultaneously assess the primary variables as well as any covariates.

The regression model is an equation in which the primary outcome variable is represented as a function of the covariates and other independent variables. The importance of each independent variable is assessed by determining whether its corresponding coefficient is significantly different from zero. If the coefficient is statistically greater than zero, then that independent variable is considered to have an effect on the dependent variable and is kept in the model; otherwise, it is discarded. The final model includes only those variables found to be statistically related to the dependent variable. The model enables the allergy data analysis system 102 to determine the strength of each independent variable relative to the others, as well as to the allergen or agent effect. In the antibiotic example, a multiple regression analysis would be appropriate for data where the level of allergy symptoms was measured twice (e.g., at baseline and at 3 weeks), and the total IgE levels higher than 1000 ng/ml was measured as an independent variable.

For studies in which the outcome variable is qualitative, other types of analysis may be employed. Some of these resemble the methods used to analyze quantitative variables. For instance, log-linear modeling may be used to develop the same types of evaluations for a qualitative outcome variable as ANOVA and ANCOVA provide for quantitative measures.

Log-linear modeling techniques are equivalent to such commonly used Chi-square methods as the Cochran-Mantel-Haenzel method. They enable the allergy data analysis system 102 to compare the distribution of allergy and control patients within outcome classes; some techniques also make it possible to determine how consistent the influence of covariates is, and to adjust for that influence.

Because qualitative variables are represented by whole numbers, these methods may use special algorithms in order to estimate quantities of interest. Finding solutions for estimating those quantities can be accomplished readily with the aid of computer programs known in the art.

Logistic regression methods are the qualitative counterparts to the multiple regression techniques described for quantitative variables. While the two methods include models and interpretations that correspond closely, logistic regression computations are not as straightforward as those for multiple regression. Even so, they enable the allergy data analysis system 102 to determine relationships between the outcome variable and independent variables. Logistic regression allows the use of either quantitative or qualitative covariates, but it is preferred that study participants have a follow-up time that is essentially the same.

In logistic regression methods, a proportion is represented by a complex formula, a part of which is a multiple regression-like expression. By estimating the coefficients for the independent variables, including the allergen exposure or agent administration, the allergy data analysis system 102 is able to determine whether a particular independent variable is statistically related to the dependent variable. The final model contains only these independent variables, the coefficients of which differ significantly from zero. Further, the logistic regression method estimates the odds ratio: a measure of the relative risk for each independent variable adjusted for the presence of the other variables. For example, if the allergen was a drug intended to treat a fungus on the toenail, and if the logistic regression measured the rate of allergy in treated subjects at 10 days after treatment, then an odds ratio of 7.9 for the treatment would imply that, adjusted for other variables in the final model, subjects who had the treatment were 7.9 times more likely to experience an allergic reaction at 10 days after treatment than patients who did not have the treatment.

The Cox regression method is another technique for analyzing qualitative outcome measures. This method can determine the effect of agents and other potential covariates even when the data do not have the same follow-up time. It yields a model and results that are analogous to those of the logistic regression method, but are not limited to patient survival outcomes. This method can be applied to, for example, an outcome that includes measurement of the time to a particular event, such as time to allergy symptom onset. A powerful characteristic of the Cox regression method is that it keeps the study participant in the analysis until he or she drops out of the study. This can be an important factor in small studies, in which statistical power can be reduced when even a modest number of participants are unavailable for follow-up.

The selection of statistical methods appropriate for safety analyses depends on many factors. If the FDA and the clinical researcher have a great deal of knowledge about adverse events, such as allergy symptoms for example, associated with a specific treatment target and/or its therapeutic agents, estimating the rate of adverse events with corresponding 95% confidence intervals may be appropriate. But if little is known about those adverse events, a more elaborate statistical treatment may be appropriate.

The most common method used to analyze adverse events is to compute freedom-from-complication rates by survival methods; one of the most commonly used analysis procedures for survival data is the Kaplan-Meier method. The popularity of this method is partly attributable to the fact that it measures the time to occurrence of an adverse event, and, like the Cox regression method, keeps participants in the life table until they drop out of a study. In addition, at the occurrence of each adverse event, the Kaplan-Meier method provides an estimate of the adverse event rate and its standard error, enabling the allergy data analysis system 102 to compute confidence intervals for each adverse event.

A related method is the life table method, in which the study duration is divided into equal segments and the proportion of events and participant drop-outs is evaluated for each segment. For example, if the study had a one-year duration, the life table could be viewed as 12 one-month segments. Calculation of rates would depend on the number of participants that entered the study each month, the number of events that occurred in that month, the number of participants that dropped out of the study in that month, and the number of participants who went on to the next month. The adverse event rate is calculated for each month rather than at the occurrence of each adverse event, and the standard error is also determined, allowing for the computation of confidence intervals.

If it is necessary to test the hypothesis that two samples (such as a control and exposed group) have the same adverse event experience for the study duration in the presence of covariates, this can be accomplished by comparing survival (freedom from complication) rates derived through use of the Cochran-Mantel-Haenzel method or an equivalent procedure. Cox regression provides a good method with which to determine the relative importance of covariates on a rate of adverse events.

Such analytical methods are useful for comparing the rates at which a treated and control group encounter their first occurrence of an adverse event, but the occurrence of multiple adverse events or multiple occurrences of the same adverse event do not lend themselves readily to a single appropriate analytical technique. A combination of non-independent analyses is preferred to completely explain the effects of multiple adverse events.

Numerical relationships detected as statistically significant by regression techniques are associations, not cause-and-effect relationships. To support the associative evidence provided by such analyses, the allergy data analysis system 102 may also make use of pre-clinical animal studies and other data that reinforce the determination of cause-and-effect, where available.

While it is generally desirable to prospectively design a study to provide statistically significant measures of safety and efficacy, retrospective analysis of study data 106 may provide adequate means for determining statistical relationships among the data. Alternatively, statistically significant measures of study data 106 may be unavailable in some cases. For example, an analysis of study data 106 may indicate an association between the allergy symptoms of a small subset of allergic patients enrolled in a clinical trial and a specific set of innate and acquired allergy determinants (e.g., genetic and IgE data, respectively) of the small subset of allergic patients. Because of the small sample size of the subset of patients, the study data 106 may lack statistical power to indicate whether the association is statistically significant (e.g., the p-value may be >0.05). The association, however, may nevertheless be of interest by virtue of, for example, (1) the degree of association; (2) the magnitude of the allergy symptoms in the subset of patients; and/or (3) a coincidence with a known mechanism of action of the innate determinant. Therefore, the claimed subject matter should not be limited to study data analysis of, for example, a specific statistical level of significance. Many applications of the allergy data analysis system 102 exist, over and above the examples provided herein.

Study data 106 may include reported or calculated mean values of the parameters discussed above such as, for example, arithmetic, geometric and/or harmonic means. Study data may also include reported or calculated statistical measures such as student's t-test, p-value, chi square value(s), and/or confidence interval or level. Alternatively, the allergy data analysis system 102 may calculate an appropriate statistical measure using raw data.

As discussed above, a query parameter may be applied to the study data 106 as a means of selecting desired, relevant, and/or statistically significant data. Such a query parameter may be accepted, for example, by the allergy data association logic 126 and/or allergy information association logic 128 as input or associated with input from a researcher 104 through a user interface 132.

In this regard, it should be understood that the herein claimed allergy data analysis system 102 can, for a given allergy, accept a query parameter that defines the level of the at least one allergy against which the association of accessed data including allergy determinants and/or allergy symptoms and/or defined allergy level (e.g., allergy information) is made before presenting a signal related to, e.g., ingestion-dependent allergy information in response to accessing data containing at least one innate determinant associated with the at least one allergy, and accessing data containing at least one acquired determinant associated with the at least one allergy.

For example, many databases may be searched singly or in combination to identify one or more allergies that are associated with innate determinants, such as for example, a specific HLA DNA sequence. Similarly, many databases exist that may be searched singly or in combination to identify data containing acquired allergy determinants associated with one or more allergies, such as total and/or specific IgE measurements, skin test results, and/or food challenge results. Similarly, many databases exist that may be searched singly or in combination to associate a given innate allergy determinant and a given acquired allergy determinant with a defined level of the allergy. Similarly, many databases exist that may be searched singly or in combination to identify one or more subpopulations that correspond to populations with specific innate and/or acquired allergy determinants.

Some allergies have a genetic component and are more likely to occur among people who trace their ancestry to a particular geographic area. People in an ethnic group often share certain versions of their genes, called alleles, which have been passed down from common ancestors. If one of these shared alleles contains a mutation that predisposes the carrier to experience a specific allergy, that allergy may be more frequently seen in that particular ethnic group than in other groups that do not carry the allele with the mutation.

Examples of genetic conditions that are more common in particular ethnic groups are sickle cell anemia, which is more common in people of African, African-American, or Mediterranean heritage; and Tay-Sachs disease, which is more likely to occur among people of Ashkenazi (eastern and central European) Jewish or French Canadian ancestry.

Linkage disequilibrium (LD) is a term used in the field of population genetics for the non-random association of alleles at two or more genetic loci, not necessarily on the same chromosome. LD describes a situation in which some combinations of alleles or genetic markers occur more or less frequently in a population than would be expected from a random assortment of allelic sequences based on their frequencies. For example, in addition to having higher levels of genetic diversity, populations in Africa tend to have lower amounts of linkage disequilibrium than do populations outside Africa, partly because of the larger size of human populations in Africa over the course of human history and partly because the number of modern humans who left Africa to colonize the rest of the world appears to have been relatively low. In contrast, populations that have undergone dramatic size reductions or rapid expansions in the past and populations formed by the mixture of previously separate ancestral groups can have unusually high levels of linkage disequilibrium.

Databases that contain study data 106 relating to, for example, the genetic make-up of a population, allergy trial information, including subject information and allergy symptoms experienced, include, for example, those found on the internet at the Entrez websites of the National Center for Biotechnology Information (NCBI). NCBI databases are internally cross-referenced and include, for example, medical literature databases such as PubMed and Online Mendelian Inheritance in Man; nucleotide databases such as GenBank; protein databases such as SwissProt; genome databases such as Refseq; and expression databases such as Gene Expression Omnibus (GEO). The uniform resource locator (URL) for the NCBI website is http://www.ncbi.rlm.nih.gov. Also useful are publication databases such as Medline and Embase.

Other databases include, for example, IMS Health databases of prescribing information and patient reporting information such as that contained in the National Disease and Therapeutic Index (NDTI) database, which provides a large survey of detailed information about the patterns and treatment of disease from the viewpoint of office-based physicians in the continental U.S. Also of use is the U.S. Food and Drug Administration's (FDA's) Adverse Event Reporting System (AERS) database. This database contains adverse drug reaction reports from manufacturers as required by FDA regulation. In addition, health care professionals and consumers send reports voluntarily through the MedWatch program. These reports become part of a database. The structure of this database is in compliance with the international safety reporting guidance issued by the International Conference on Harmonization. The FDA codes all reported adverse events using a standardized international terminology called MedDRA (the Medical Dictionary for Regulatory Activities). Among AERS system features are the on-screen review of reports, searching tools, and various output reports. Another adverse drug events database is DIOGENES®, a database consisting of two sub-files: Adverse Drug Reactions (ADR) and Adverse Event Reporting System (AERS). ADR records contain data regarding a single patient's experience with a drug or combination of drugs as reported to the FDA. Since 1969, the FDA has legally-mandated adverse drug reaction reports from pharmaceutical manufacturers and maintained them in their ADR system. In November 1997, the ADR database was replaced by the AERS. Other adverse event reporting databases include, for example, the Vaccine Adverse Event Reporting System (VAERS).

In one embodiment, the allergy data analysis system 102 carries out the method of accepting an input identifying at least one allergy, accessing data containing at least one innate determinant associated with the at least one allergy, and accessing data containing at least one acquired determinant associated with the at least one allergy, and presenting a signal related to ingestion-dependent allergy information associated with a defined level of the at least one allergy in response to accessing data containing at least one innate determinant associated with the at least one allergy, and accessing data containing at least one acquired determinant associated with the at least one allergy. In doing so, the allergy data analysis system 102 may identify allergy information (e.g., a specific combination of innate [i.e., one or more molecular or cellular parameters such as, for example, DNA sequence, protein sequence, or protein expression level] and acquired [i.e., environmentally-induced parameters such as, for example, specific IgE titers directed to an allergen] allergy determinants) that is associated with a defined level of the allergy (e.g., allergy symptom incidence or severity of a defined level).

Data associated with a population or subpopulation, as described and claimed herein, refer generally to data regarding a human or animal population or a human or animal subpopulation. For example, data associated with a population or subpopulation may be, for example, reported in the scientific literature, self-reported, measured, reported in survey results, present in archival documentation, and/or anecdotal in nature.

Data characterized by, for example, one or more genetic profiles may not, at first glance, correspond to a known, clinically-defined segment of the global or a national population. The allergy data analysis system 102 may therefore perform the additional step of associating an innate allergy determinant with subpopulation identifier data to identify one or more relevant patient populations. As an example, study data associated with a defined level of at least one allergy may be molecular data or other data specifically associated with known ethnic, gender, age or other demographic features. As a specific example, study data characterized by a specific DNA sequence and total IgE level resulting in severe allergic symptoms may be matched with an ethnic genomic DNA database(s) and/or other medical database(s) to identify an ethnic group in which the specific DNA sequence is more common than in the general population. Such an ethnic population may accordingly be identified as of increased risk for the allergy, where the total IgE level complements the DNA sequence predictor.

Although many other examples are provided herein and with reference to the various figures, it should be understood that many types and instances of study data 106 may play a role in the use and application of the various concepts referenced above and described in more detail herein. The allergy data analysis system 102 may store such study data 106 in a database 136 or other memory, for easy, convenient, and effective access by the researcher 104.

The study data 106 may include, for example, not only clinical study data and/or corresponding allergy determinants and/or information, but also various other parameters and/or characteristics related to subjects or patients who experience allergy 302 (FIG. 3) or who have been exposed to an allergen, examples of which are provided herein. Through detailed storage, organization, processing, and use of the study data 106, the researcher 104 may be assisted in identifying appropriate data, subpopulations, allergies, and agents, in order, for example, to identify populations at risk for an allergy 302 (FIG. 3), or relatively resistant to an allergy 302 (FIG. 3). Ordered assignment, processing, and/or storage of information within the study data 106, as described herein, facilitates and/or enables such recall, access, and/or use of the study data 106 by the researcher 104 in identifying (1) allergy information associated with a defined level of allergy, including data containing at least one innate determinant associated with at least one allergy and data containing at least one acquired determinant associated with the at least one allergy, (2) an agent associated with a defined level of at least one allergy, and/or (3) subpopulation identifier data associated with allergy information and/or an innate allergy determinant.

In the allergy data analysis system 102, allergy data association logic 126 and/or allergy information association logic 128 may be used to store, organize, access, search, process, recall, or otherwise use the information stored in the study data 106. For example, the allergy data association logic 126 and/or allergy information association logic 128 may access a database management system (DBMS) engine 130, which may be operable to perform computing operations to insert or modify new data into/within the study data 106, perhaps in response to new research or findings, or in response to a preference of the researcher 104. For example, if a new allergen is discovered to be a health threat to the general population, the researcher 104 may access the allergy data analysis system 102 and/or allergy data association logic 126 and/or allergy information association logic 128 through a user interface 132, in order to use the DBMS engine 130 to associate the new allergen with allergy information (including, for example, innate and acquired allergy determinants) that is associated with an acceptable incidence of the allergic reaction to the allergen or a closely related allergen (i.e., with a defined level).

As another example, if allergy information from a newly published allergy study, e.g., a clinical trial report, can be associated with a subpopulation that was not specifically identified in the clinical trial report by the trial sponsors, the allergy data analysis system 102, allergy data association logic 126 and/or allergy information association logic 128 may present the subpopulation together with a signal related to the allergy information to a user interface 132 in response to input optionally including a query parameter from a researcher 104. Such identification may be performed by use of a query parameter that can select, for example, a defined severity limit for an allergic reaction.

Similarly, in a case where a researcher 104 seeks, for example, to identify subject data that is associated with the presence or absence of allergy symptoms for a given allergy 302 (FIG. 3), the researcher 104 may access the user interface 132 to use the allergy data association logic 126 and/or allergy information association logic 128, and/or DBMS Engine 130 to enter an allergy 302 that is associated with innate determinant data and acquired determinant data from a particular population, such that allergy diagnosis is enhanced for that population. For example, if a researcher 104 is interested in populations that are particularly susceptible to a specific allergy, then the researcher 104 may input the allergy as a query parameter via the user interface 132 in order to access innate and acquired allergy determinant data that are associated with, for example, particularly high levels of allergy symptoms. The allergy data analysis system 102, including allergy data association logic 126 and/or allergy information association logic 128, can then link the innate and acquired allergy determinant data to human subpopulations by virtue of common innate and/or environmental determinants, thereby identifying those subpopulations that are predisposed to experience the allergy in question. In such an example, a researcher 104 may input a query parameter that, for example, specifies a level of allergy symptom or a statistically-defined level of allergy symptom.

As another example, if a researcher 104 is interested in finding an agent for use in the context of a particular treatment target or class of targets (e.g., beta blockers, statins, etc.) that will not elicit an allergy upon administration, then the researcher 104 may search for study data 106, allergy information 310 (FIG. 3), and/or subpopulations that are not associated with significant allergy symptoms in response to administration of the agent. The allergy data association logic 126 and/or allergy information association logic 128 may interface with the DBMS engine 130 to obtain, from the study data 106, data and/or subpopulations that are associated with an allergy symptom profile within a defined limit. In this case, once the data, allergy information, and/or subpopulation is identified, the allergy data analysis system 102 and/or allergy data association logic 126 and/or allergy information association logic 128 may present a signal related to the allergy information (e.g., a positive or negative association, or the character of the association) and/or subpopulation to the user interface 132 and the researcher 104 as one(s) that meets the input criteria, including the query parameter.

Allergy symptoms may include, for example, rhinitis, conjunctivitis, vasoconstriction, runny nose, tearing eyes, burning or itching eyes, red eyes, swollen eyes, itching nose, mouth, throat, skin, or any other area, wheezing, coughing, difficulty breathing, hives (skin wheals, urticaria), skin rashes, stomach cramps, vomiting, diarrhea, and/or headache, as well as incidence rates and degrees of the above symptoms.

As a general matter, a researcher 104, e.g., a pharmaceutical or nutraceutical scientist, or other biomedical scientist, may not be aware of currently available content of the study data 106. Thus, the allergy data analysis system 102 and/or allergy data association logic 126 and/or allergy information association logic 128 provides the researcher 104 with fast, accurate, current, and/or comprehensive allergy study information, and also provides techniques to ensure that the information remains accurate, current, and/or comprehensive, by allowing the addition and/or modification of the existing study data 106, as new study information becomes available.

In FIG. 1, the allergy data analysis system 102 is illustrated as possibly being included within a research device 134. The research device 134 may include, for example, a mobile computing device, such as a personal digital assistant (PDA), or a laptop computer. Of course, virtually any other computing device may be used to implement the allergy data analysis system 102, such as, for example, a workstation, a desktop computer, a networked computer, a collection of servers and/or databases, or a tablet PC.

Additionally, not all of the allergy data analysis system 102 need be implemented on a single computing device. For example, the study data 106 may be stored on a remote computer, while the user interface 132 and/or allergy data association logic 126 and/or allergy information association logic 128 are implemented on a local computer. Further, aspects of the allergy data analysis system 102 may be implemented in different combinations and implementations than that shown in FIG. 1. For example, functionality of the DBMS engine 130 may be incorporated into the allergy data association logic 126 and/or allergy information association logic 128, and/or the study data 106. Allergy data association logic 126 and/or allergy information association logic 128 may include, for example, fuzzy logic and/or traditional logic steps. Further, many methods of searching databases known in the art may be used, including, for example, unsupervised pattern discovery methods, coincidence detection methods, and/or entity relationship modeling.

The study data 106 may be stored in virtually any type of memory that is able to store and/or provide access to information in, for example, a one-to-many, many-to-one, and/or many-to-many relationship. Such a memory may include, for example, a relational database and/or an object-oriented database, examples of which are provided in more detail herein.

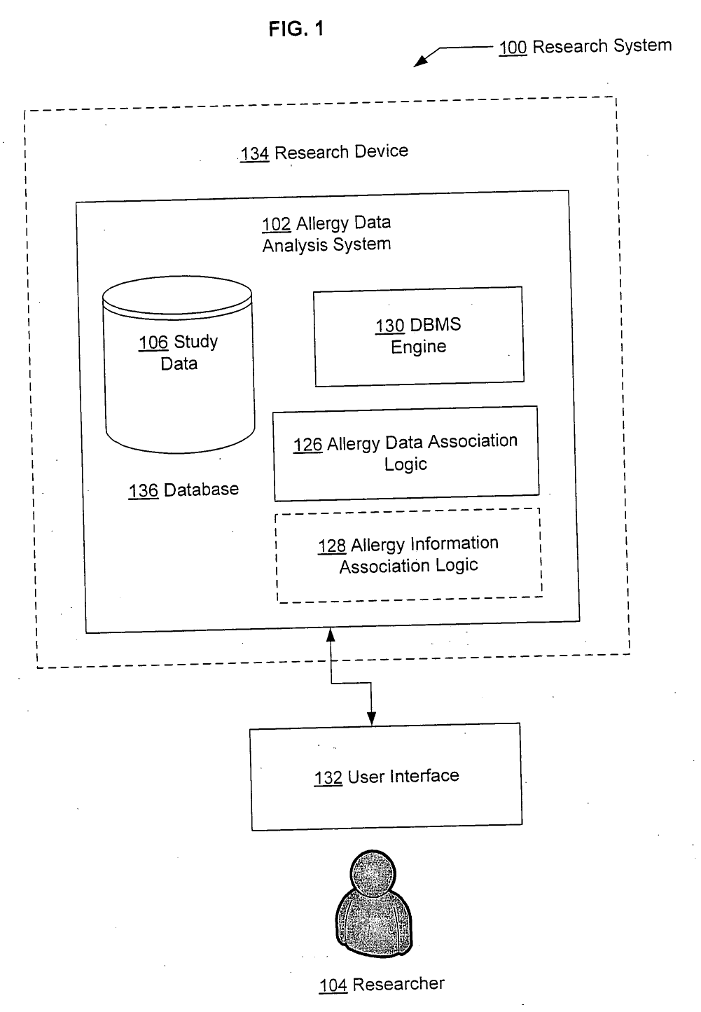

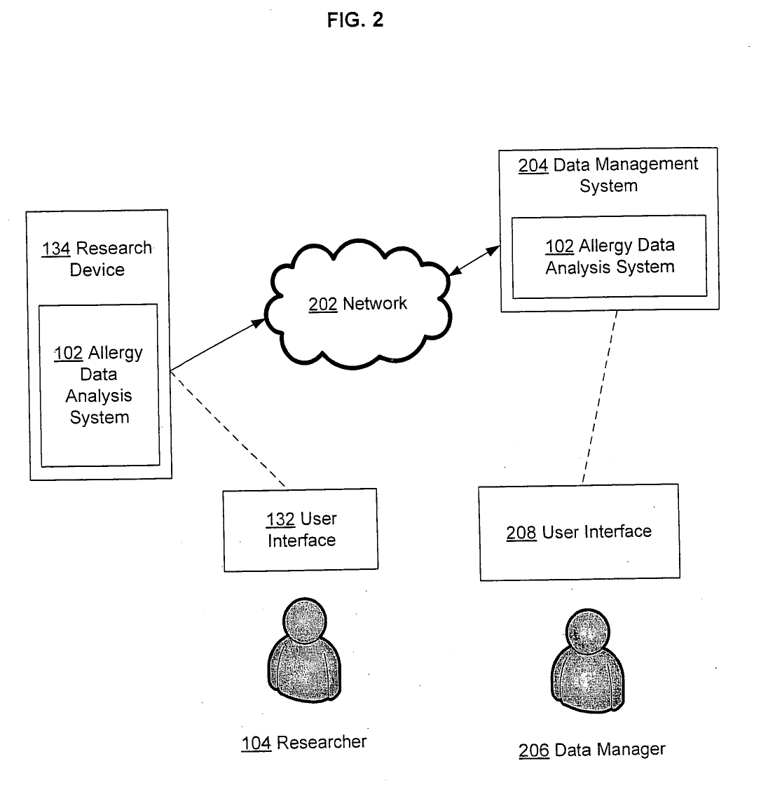

FIG. 2 illustrates certain alternative embodiments of the research system 100 of FIG. 1. In FIG. 2, the researcher 104 uses the user interface 132 to interact with the allergy data analysis system 102 deployed on the research device 134. The research device 134 may be in communication over a network 202 with a data management system 204, which also may be running the allergy data analysis system 102; the data management system 204 may be interacted with by a data manager 206 through a user interface 208. Of course, it should be understood that there may be many researchers other than the specifically-illustrated researcher 104, each with access to an individual implementation of the allergy data analysis system 102. Similarly, multiple data management systems 204 may be implemented.

In this way, the researcher 104, who may be operating in the field, e.g., in an office, laboratory and/or hospital environment, may be relieved of a responsibility to update or manage content of the study data 106, or other aspects of the allergy data analysis system 102. For example, the data management system 204 may be a centralized system that manages a central database of the study data 106, and/or that deploys or supplies updated information from such a central database to the research device 134.

FIG. 3 illustrates an alternative embodiment of the study data 106 associated with the research system 100 of FIG. 1. In FIG. 3, and in the various examples herein, a particular nomenclature is used for the terms described above and related terms, in order to provide consistency and clarity of description. However, it should be understood that other terminology may be used to refer to the same or similar concepts.

In FIG. 3, allergies 302 (e.g., 302a, 302b, 302c, etc.) are stored and organized with respect to a plurality of allergy study data 304. The allergy study data 304 include many of the terms and concepts just described, as well as additional, but not exhaustive, terms and concepts that may be relevant to the use and operation of the allergy data analysis system 102.

For example, the allergy study data 304 may include innate allergy data 306, also referred to as an innate determinant associated with at least one allergy. Innate allergy data 306 may refer to, for example, genetic or other personal characteristics data associated with allergy that are essentially independent of environmental exposure to allergens. For example, innate allergy data 306 may include an eotaxin gene polymorphism that is found, in its homozygous form, at a high frequency in patients with asthma (see U.S. Pat. No. 6,548,245).

Allergy study data 304 also may include acquired allergy data 308, also referred to as an acquired determinant associated with at least one allergy. Acquired allergy data 308 may refer to, for example, essentially environmentally-dependent personal characteristics associated with allergy, such as increased total IgE levels, levels of specific IgE directed to an allergen, a positive reaction to an allergy skin test or results of an allergy food challenge.

Allergy information 310 may refer, for example, to data reflecting the association of a particular combination of one or more innate allergy determinants and one or more acquired allergy determinants with allergy symptoms, for example, as reported in allergy studies. Allergy information 310 may include, for example, innate and acquired allergy determinants associated with a defined level of incidence of nausea or abdominal pain following ingestion of, or skin exposure to, an allergen. One example of allergy information is ingestion-dependent allergy information 310b. Ingestion-dependent allergy information 310b is allergy information that relates to the association of innate and acquired allergy determinants with allergy symptoms resulting from the ingestion of at least one allergen.

Allergy study data 304 may also include subpopulation identifier data 312. Subpopulation identifier data 312 may refer, for example, to data that tends to distinguish one subpopulation from other subpopulations or a general population, other than innate allergy data 306 in a specific case. Subpopulation identifier data 312, for example, may include a genomic DNA sequence that is specific to a subpopulation and which tends to distinguish that subpopulation from other subpopulations or a general population. Subpopulation identifier data 312 may correlate with innate allergy data 306 and further characterize innate allergy data 306 in terms of readily recognizable populations (e.g., ethnic groups, blue-eyed people, or women).

In an alternative embodiment, innate allergy data 306 may be used as a query parameter to search one or more databases to identify subpopulation identifier data 312 that are associated with the innate allergy data 306. Such subpopulation identifier data 312 may indicate clinically relevant subpopulation(s) for the allergy of interest. For example, using the allergy data analysis system 102 and/or agent identifier logic 126 and/or subpopulation identifier logic 128, an allergy may be identified that is found with a particular frequency in a subpopulation characterized by, for example, a specific haplotype profile. That specific haplotype profile may then be used as a search parameter to search biomedical databases for prospective patient populations that are associated with the specific haplotype profile, e.g., individuals with primarily Mediterranean ancestry. The allergy data analysis system 102 and/or agent identifier logic 126 and/or subpopulation identifier logic 128 may subsequently access acquired allergy data 308 that, with the innate allergy determinant, comprise allergy information associated with a defined allergy level, thereby forming a relation to the subpopulation identifier data 312-identified prospective patient population in terms of allergy susceptibility or resistance (e.g., individuals with primarily Mediterranean ancestry).

Many other examples of relationships and associations between the various allergy study data 304 and/or the allergy 302 may be defined or determined and stored in the study data 106 according to the allergy data association logic 126 and/or the allergy data association logic 126 and/or allergy information association logic 128. Certain of these examples are provided herein.

Additionally, although the study data 106 is illustrated conceptually in FIG. 3 as a flat table in which one or more of the selected allergies 302 are associated with one or more of the allergy study data 304, it should be understood that this illustration is for explanation and example only, and is not intended to be limiting in any way with respect to the various ways in which the study data 106 may be stored, organized, accessed, queried, processed, recalled, or otherwise used.

For example, the study data 106 may be organized into one or more relational databases. In this case, for example, the study data 106 may be stored in one or more tables, and the tables may be joined and/or cross-referenced in order to allow efficient access to the information contained therein. Thus, the allergies 302 may define a record of the database(s) that are associated with various ones of the allergy study data 304.

In such cases, the various tables may be normalized so as, for example, to reduce or eliminate data anomalies. For example, the tables may be normalized to avoid update anomalies (in which the same information would need to be changed in multiple records, and which may be particularly problematic when database 136 is large), deletion anomalies (in which deletion of a desired field or datum necessarily but undesirably results in deletion of a related datum), and/or insertion anomalies (in which insertion of a row in a table creates an inconsistency with another row(s)). During normalization, an overall schema of the database 136 may be analyzed to determine issues such as, for example, the various anomalies just referenced, and then the schema is decomposed into smaller, related schemas that do not have such anomalies or other faults. Such normalization processes may be dependent on, for example, desired schema(s) or relations between the allergies 302 and/or allergy study data 304, and/or desired uses of the study data 106.

Uniqueness of any one record in a relational database holding the study data 106 may be ensured by providing or selecting a column of each table that has a unique value within the relational database as a whole. Such unique values may be known as primary keys. These primary keys serve not only as the basis for ensuring uniqueness of each row (e.g., allergy) in the database, but also as the basis for relating or associating the various tables within one another. In the latter regard, when a field in one of the relational tables matches a primary key in another relational table, then the field may be referred to a foreign key, and such a foreign key may be used to match, join, or otherwise associate (aspects of) the two or more related tables.

FIG. 3 and associated potential relational databases represent only one example of how the study data may be stored, organized, accessed, recalled, or otherwise used.

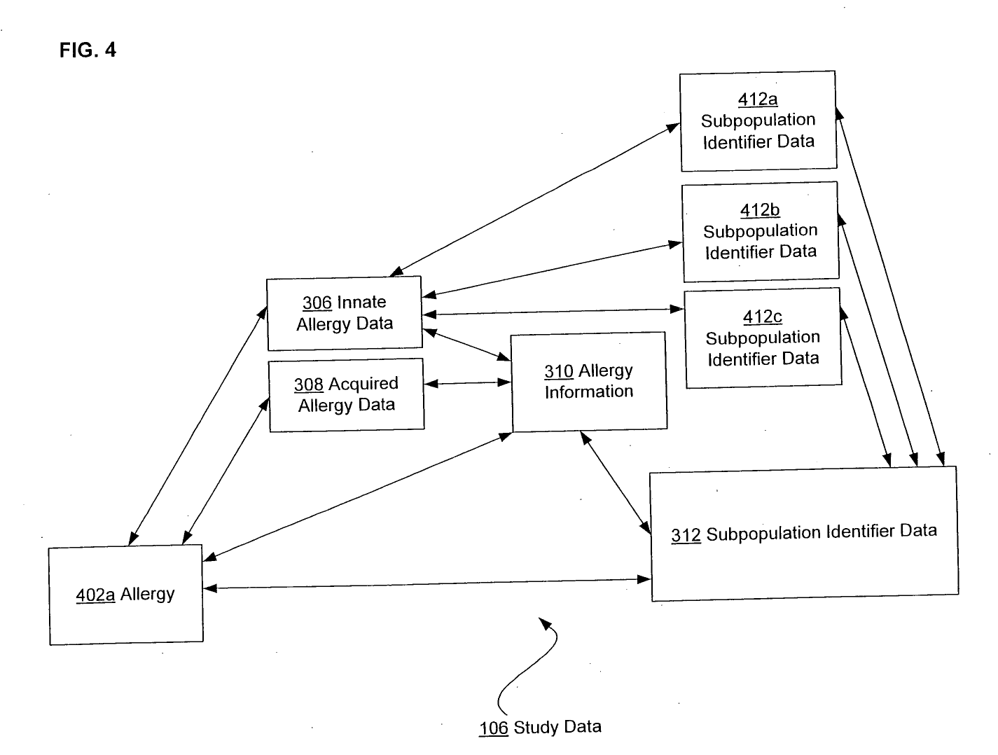

FIG. 4 illustrates another alternative embodiment of study data 106 associated with the research system 100 of FIG. 1, in which the study data 106 is conceptually illustrated as being stored in an object-oriented database.

In such an object-oriented database, the various allergies 302 and/or allergy study data 304 may be related to one another using, for example, links or pointers to one another. FIG. 4 illustrates a conceptualization of such a database structure in which the various types of study data are interconnected, and is not necessarily intended to represent an actual implementation of an organization of the study data 106.

The concepts described above may be implemented in the context of the object-oriented database of FIG. 4. For example, an instance 402a of the allergy 302 may be associated with innate allergy data 306 and acquired allergy data 308. An allergy 302 or instance of one or more allergies may be associated with data corresponding to an innate allergy determinant and an acquired allergy determinant. For example, allergy 402a may be associated with innate allergy data 306, acquired allergy data 308 and allergy information 310 indicating a defined level of the allergy 402a.

Similarly, allergy information 310 may be associated with subpopulation identifier data 312. For example, allergy information 310 associated with allergy 402a may be associated with subpopulation identifier data 312. Further, three instances of subpopulation identifier data 312, for example instance 1 (412a), instance 2 (412b), and instance 3 (412c), may be associated with the allergy information 310 and/or innate allergy data 306.

Many other examples of databases and database structures also may be used. Other such examples include hierarchical models (in which data is organized in a tree and/or parent-child node structure), network models (based on set theory, and in which multi-parent structures per child node are supported), or object/relational models (combining the relational model with the object-oriented model).

Still other examples include various types of eXtensible Mark-up Language (XML) databases. For example, a database may be included that holds data in some format other than XML, but that is associated with an XML interface for accessing the database using XML. As another example, a database may store XML data directly. Additionally, or alternatively, virtually any semi-structured database may be used, so that context may be provided to/associated with stored data elements (either encoded with the data elements, or encoded externally to the data elements), so that data storage and/or access may be facilitated.

Such databases, and/or other memory storage techniques, may be written and/or implemented using various programming or coding languages. For example, object-oriented database management systems may be written in programming languages such as, for example, C++ or Java. Relational and/or object/relational models may make use of database languages, such as, for example, the structured query language (SQL), which may be used, for example, for interactive queries for information and/or for gathering and/or compiling data from the relational database(s).

As referenced herein, the allergy data analysis system 102 and/or allergy data association logic 126 and/or allergy information association logic 128 may be used to perform various data querying and/or recall techniques with respect to the study data 106, in order to facilitate determination of suitable allergy information 310. For example, where the study data 106 is organized, keyed to, and/or otherwise accessible using one or more of the allergies 302 and/or allergy study data 304, various Boolean, statistical, and/or semi-boolean searching techniques may be performed.

For example, SQL or SQL-like operations over one or more of the allergies 302 and/or allergy study data 304 may be performed, or Boolean operations using the allergies 302 and/or allergy study data 304 may be performed. For example, weighted Boolean operations may be performed in which different weights or priorities are assigned to one or more of the allergies 302 and/or allergy study data 304, perhaps relative to one another. For example, a number-weighted, exclusive-OR operation may be performed to request specific weightings of desired or undesired) study data to be included or excluded.

The researcher 104 may input peanut allergy as the allergy 302, with the goal of identifying allergy information 310 that includes examples of innate allergy data 306 that belong to a particular class, for example, HLA, cytokine, or immunoglobulin gene sequence determinants. For example, the researcher 104 may want to identify allergies 302 that are associated with a certain class of innate determinant and a certain class of acquired determinant, e.g., statistically significant raised total IgE levels in allergic individuals. Having identified a set of innate and acquired allergy determinants meeting these criteria, the researcher 104 could then use the allergy data analysis system 102 to search relevant study data 106 using a query parameter such as a specific level of bronchoconstriction to identify allergy information 310 associated with acceptable levels of bronchoconstriction. In another example, the researcher 104 may specify relatively low levels of allergy incidence combined with a high degree of allergy symptom severity in an attempt to identify allergy information corresponding to individuals with a high acute risk of allergy. Such a screen may identify different subpopulations for which desired allergy information is available.

As another example, the researcher 104 may start with a preferred subpopulation, characterized by either subpopulation identifier data 312 or innate allergy data 306, and proceed to identify allergies that are, for example, not experienced at a defined level for that subpopulation.

The researcher 104 may specify such factors as subpopulation identifier data 312 or innate allergy data 306 as query parameters, using, for example, the user interface 132. For example, the researcher 104 may designate one or more of the allergies 302/allergy study data 304, and assign a weight or importance thereto, using, for example, a provided ranking system. In this regard, and as referenced herein, it should be understood that the researcher 104 may wish to find particular groups of individuals at increased risk for a drug allergy, e.g., codeine allergy. The researcher 104 may not be aware of a subpopulation(s) of prospective patients that may be at increased risk for codeine allergy. However, the researcher 104 may query the allergy data analysis system 102 based on the desired allergy 302, and may thereby discover allergy information 310 corresponding to one or more groups that are particularly susceptible to codeine allergy. The researcher 104 may further query the allergy data analysis system 102 based on the innate allergy data 306 (i.e., part of the allergy information 310) to elicit subpopulation identifier data 312 that describe one or more clinically relevant prospective patient subpopulations at risk for codeine allergy.

Similarly, data analysis techniques (e.g., data searching) may be performed using the study data 106, perhaps over a large number of databases. For example, the researcher 104 may input an allergy of interest. Then, the researcher may receive a listing of allergy information ranked according to some input criteria. For example, the researcher 104 may receive a listing of instances of allergy information 310, ordered by allergy symptom severity, incidence of a particular allergy symptom in a general population, and incidence of a particular allergy in a subpopulation having innate allergy data and acquired allergy data. In this way, for example, if a defined level of allergy symptom severity is the query parameter input provided by the researcher 104, then the researcher 104 may select allergy information 310 according to ranked allergy symptom severity.

By way of further example, other parameters/characteristics may be factored in. For example, elimination pathways may be tracked, databased, and/or weighted for use in the study data 106 and/or the allergy data analysis system 102. For example, if a particular allergen is typically eliminated by the liver before sensitization, then, in a case where allergy information 310 is identified that is characterized by allergy symptoms in individuals with compromised liver function (in terms of, e.g., innate allergy data and acquired allergy data), such allergy information 310 may be used to provide an allergy risk warning to individuals with compromised liver function with respect to ingestion of the particular allergen. Algorithms implementing such query/recall/access/searching techniques may thus use Boolean or other techniques to output, for example, a thresholded, rank-ordered list. The allergy data association logic 126 and/or allergy information association logic 128 may then assign a key or other identifier to such a list(s), for easier use thereof the next time a like query is performed.

Design and testing of querying techniques in particular implementations of the allergy data analysis system 102 may involve, for example, entry of candidate allergies 302/allergy study data 304 (or instances thereof) into a database(s), along with associated test results and/or affinity metrics that may be used to determine/weight targets or sets of targets. Then, an identifier may be generated that is unique to the treatment target set(s).

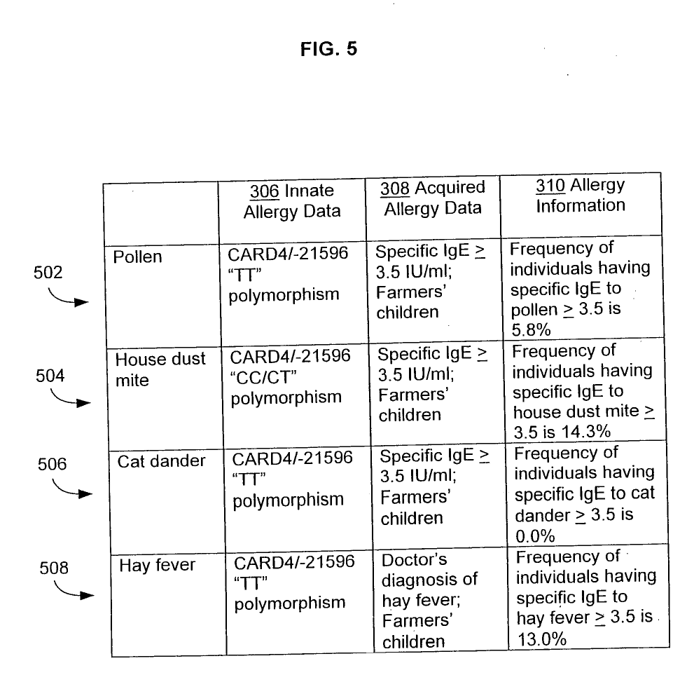

FIG. 5 illustrates another alternative embodiment of study data 106 associated with the research system 100 of FIG. 1, with specific examples of allergies 302 and allergy study data 304. In particular, FIG. 5 provides or refers to example results from a related technical paper, which is specifically referenced below.

For example, the first through fourth rows of the table of FIG. 5 (i.e., rows 502, 504, 506, and 508, respectively) refer to examples that may be found in Eder et al., “Association between exposure to farming, allergies and genetic variation in CARD4/NOD1,” Allergy, vol. 61, pp. 1117-24(2006), which is hereby incorporated by reference in its entirety, and which may be referred to herein as the Eder reference.

In the Eder reference, data are reported for allergies to various inhaled allergens among children genotyped for a particular gene sequence, CARD4/NOD1. Eder et al. studied the association of asthma, hay fever, and allergen-specific serum IgE with exposure to a farming environment and with levels of endotoxin and muramic acid measured in house dust samples. For example, the association of pollen-specific IgE levels in children with a specific CARD4/NOD1 genotype was associated with farm life, and with the lower and upper 50^{th} percentile of exposure to endotoxin in the environment. The association provided a basis for calculating an odds ratio as a measure of the event frequency, i.e., what frequency of children with a specific genotype and specific pollen IgE level were raised on a farm or not raised on a farm.

Rows 502, 504, 506, and 508 represent fields of data reported for allergies to pollen, house dust mite, cat dander, and hay fever, respectively. The Eder reference examined 668 children for their CARD4/NOD1 genotype and defined allergy to pollen, house dust mite, and cat dander as a serum specific IgE level for each allergen ≧3.5 IU/ml. Hay fever allergy was defined in children whose parents reported a doctor's diagnosis of hay fever in their child. The proportions of children with asthma, hay fever, and atopic sensitization were compared between farmer's and nonfarmer's children within the genotypes for the CARD4/NOD1 polymorphisms using the chi-squared test and the Fisher's exact test, respectively. Mantel Haenszel odds ratios for the association between farming and phenotype were computed and tested for homogeneity across genotypes. When a univariate test was suggestive, (P<0.2) of an association, a logistic regression model was used to control for potential confounders. When using logistic regression models, the log likelihood ratio test was applied to test for interaction between exposure and genotypes. The role of exposure to endotoxin and to levels of muramic acid concentrations in the association between CARD4/NOD1 genotypes and asthma and allergies was assessed in a similar manner.

As shown in row 502, allergy information 310 is present in the form of a 5.8% frequency of farmers' children having the CARD4/-21596 “TT” polymorphism (innate allergy data 306, or “innate allergy determinant”), and a specific pollen IgE level ≧3.5 and a farm upbringing (acquired allergy data 308, or “acquired allergy determinant”). A calculated and reported 0.26 odds ratio for farmers' children having the CARD4/-21596 “TT” polymorphism and a specific pollen IgE level ≧3.5 relative to nonfarmers' children is also allergy information 310 for pollen allergy 502. Thus, the odds ratio for the group with the specific innate and acquired allergy determinants is allergy information that gives an indication of differential allergy frequency for that group relative to other groups.

As shown in row 504, allergy information 310 is present in the form of a 14.3% frequency of farmers' children having the CARD4/-21596 “CC/CT” polymorphism (innate allergy data 306, or “innate allergy determinant”), and a specific house dust mite IgE level ≧3.5 and a farm upbringing (acquired allergy data 308, or “acquired allergy determinant”). A calculated and reported 2.05 odds ratio for farmers' children having the CARD4/-21596 “CC/CT” polymorphism and a specific house dust mite IgE level ≧3.5 relative to nonfarmers' children is also allergy information 310 for dust mite allergy 504. Thus, the odds ratio for the group with the specific innate and acquired allergy determinants is allergy information that gives an indication of differential allergy frequency for that group relative to other groups.

As shown in row 506, allergy information 310 is present in the form of a 0.0% frequency of farmers' children having the CARD4/-21596 “TT” polymorphism (innate allergy data 306, or “innate allergy determinant”), and a specific cat dander IgE level ≧3.5 and a farm upbringing (acquired allergy data 308, or “acquired allergy determinant”). A calculated and reported 0.0 odds ratio for farmers' children having the CARD4/-21596 “TT” polymorphism and a specific cat dander IgE level ≧3.5 relative to nonfarmers' children is also allergy information 310 for cat dander allergy 506. Thus, the odds ratio for the group with the specific innate and acquired allergy determinants is allergy information that gives an indication of differential allergy frequency for that group relative to other groups.

As shown in row 508, allergy information 310 is present in the form of a 1.7% frequency of farmer's children having the CARD4/-21596 “TT” polymorphism (innate allergy data 306, or “innate allergy determinant”), and a doctor's hay fever diagnosis and a farm upbringing (acquired allergy data 308, or “acquired allergy determinant”). A calculated and reported 0.11 odds ratio for farmers' children having the CARD4/-21596 “TT” polymorphism and a doctor's hay fever diagnosis relative to nonfarmers' children is also allergy information 310 for hay fever allergy 508. Thus, the odds ratio for the group with the specific innate and acquired allergy determinants is allergy information that gives an indication of differential allergy frequency for that group relative to other groups.

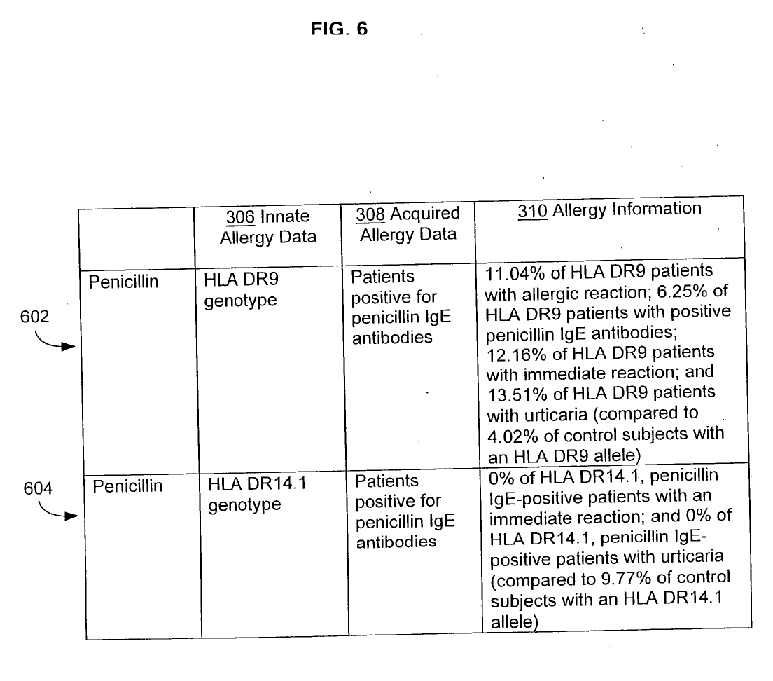

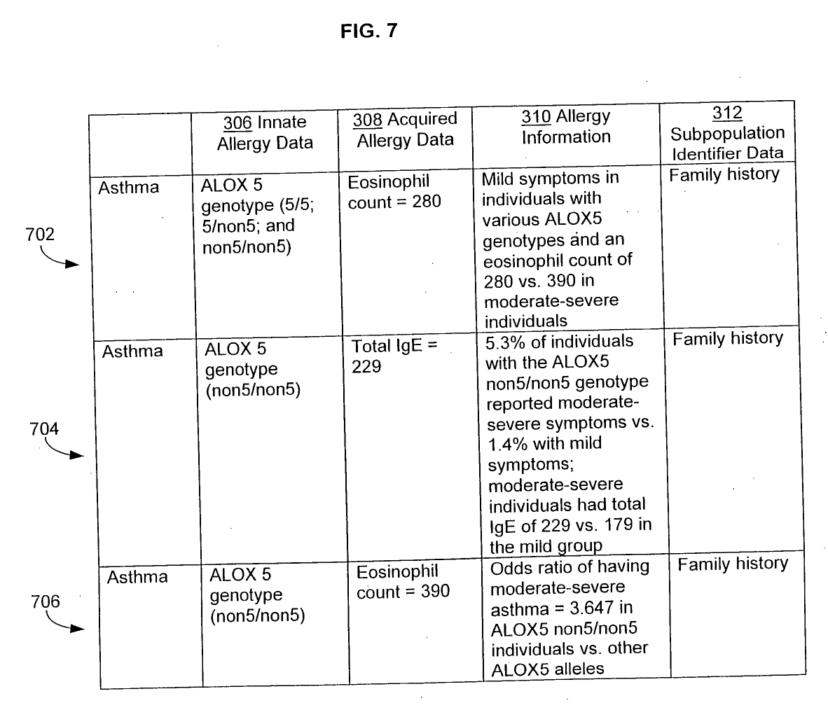

FIG. 6 illustrates another alternative embodiment of study data 106 associated with the research system 100 of FIG. 1, with specific examples of allergy study data 304. In particular, FIG. 6 provides or refers to example results from a related technical paper, which is specifically referenced below.

For example, the first and second rows of the table of FIG. 6 (i.e., rows 602 and 604, respectively) refer to examples that may be found in Yang et al., “HLA-DRB genotype and specific IgE responses in patients with allergies to penicillins,” Chin. Med. J., vol. 119(6), pp. 458-66 (2006), which is hereby incorporated by reference in its entirety, and which may be referred to herein as the Yang reference.

In the Yang reference, data are reported for allergies to penicillins among 113 allergy patients genotyped for particular HLA-DRB alleles. The Yang reference investigated the relationship between HLA-DRB genotype and allergies to various penicillins. For example, a significantly increased frequency of the DR9 allele was found in 77 patients with allergic reaction, and the same was true in those with immediate reaction and urticaria, respectively (p=0.0111; p=0.01 g; p=0.005, respectively), and a significantly decreased frequency of the DR14.1 allele was found in 80 patients with positive IgE antibodies, with immediate reaction and with urticaria compared with control subjects (p=0.024, p=0.038; p=0.038, respectively).

Rows 602 and 604 represent fields of data reported for allergies to penicillin. The Yang reference examined 113 allergy patients and 87 healthy subjects for their HLA-DRB alleles. Of the 113 allergy patients genotyped, 35 had positive skin test as well as specific IgE antibodies. Significance of the observed associations was evaluated using chi-square or Fisher's exact test if any value in a 2×2 table was less than 5. A p-value of less than 0.05 was considered statistically significant.

Rows 602 and 604 contain study data from the Yang reference, showing allergy study data. As shown in row 602, innate allergy data 306 was identified in terms of the HLA DR9 genotype. Acquired allergy data 308 was also identified in terms of patients with specific penicillin IgE antibodies. Allergy information 310 is present in the form of 11.04% of HLA DR9 patients with allergic reaction; 6.25% of HLA DR9 patients with positive penicillin IgE antibodies; 12.16% of HLA DR9 patients with immediate reaction; and 13.51% of HLA DR9 patients with urticaria (compared to 4.02% of control subjects with an HLA DR9 allele). Thus, the specific innate and acquired allergy determinant data among patients experiencing penicillin allergy is allergy information 310 that gives an indication of differential allergy frequency for that group relative to other groups.

As shown in row 604, innate allergy data 306 was identified in terms of the HLA DR14.1 allele genotype. Acquired allergy data 308 was also identified in terms of patients positive for penicillin-specific IgE antibodies. Allergy information 310 is present in the form of 0% of HLA DR14.1, penicillin IgE-positive patients with an immediate reaction; and 0% of HLA DR14.1, penicillin IgE-positive patients with urticaria (compared to 9.77% of control subjects with an HLA DR14.1 allele). Thus, the specific innate and acquired allergy determinant data among patients experiencing penicillin allergy is allergy information 310 that gives an indication of differential allergy frequency for that group relative to other groups.

FIG. 7 illustrates alternative embodiments of study data 106 associated with the research system 100 of FIG. 1, with specific examples of allergy study data 304. In particular, FIG. 7 provides or refers to an example from a related technical paper, which is specifically referenced below.

For example, FIG. 7 refers to examples that may be found in Kalayci et al., “ALOX5 promoter genotype, asthma severity and LTC₄ production by eosinophils,” Allergy, vol. 61, pp. 97-103 (2006), which is hereby incorporated by reference in its entirety, and which may be referred to herein as the Kalayci reference.

In the Kalayci reference, data are reported relating to the relationship between ALOX5 gene variants and asthma severity. The Kalayci reference genotyped the ALOX5 core promoter of 621 children with mild or moderate-severe asthma, and total IgE levels and eosinophil counts were measured for each subject. For example, more asthmatic children bearing the non5/non5 genotype had moderate-severe asthma than children with the 5/5 genotype (5.3% vs. 1.4%, p=0.008).

Rows 702, 704, and 706 represent fields of data reported for children with asthma. In the Kalayci reference, factors likely to be effective in determining the severity of asthma, including ALOX5 genotype, were identified by logistic regression analyses. The cohort was split into mild and moderate-severe asthma. The Kalayci reference examined the following variables: age, gender, age of onset, skin test positivity, total IgE level, peripheral blood eosinophil count, exposure to tobacco smoke, animal ownership, family history of atopic diseases, LTC₄ synthase genotype, and ALOX5 genotype. Univariate analyses were followed by multivariate logistic regression. A two-sided p-value of <0.05 was considered significant.

Rows 702, 704, and 706 contain study data 106 from the Kalayci reference, showing allergy study data 304. As shown in row 702, innate allergy data 306 was identified in terms of the ALOX5 genotype 5/5. Acquired allergy data 308 was also identified in terms of individuals with an eosinophil count of 280. Allergy information 310 is present in the form of mild asthma symptoms in individuals with various ALOX5 genotypes and an eosinophil count of 280. Thus, the specific innate and acquired allergy determinant data among individuals experiencing mild asthma is allergy information 310 that gives an indication of differential allergy severity for that group relative to other groups.

As shown in row 704, innate allergy data 306 was identified in terms of the ALOX5 non5/non5 allele genotype. Acquired allergy data 308 was also identified in terms of a total IgE level of 229. Allergy information 310 is present in the form of moderate-severe symptoms observed in the ALOX5 non5/non5 allele (5.3% moderate-severe vs. 1.4% of mild) and total IgE level of 229 (229 total IgE for the moderate-severe group vs. 179 total IgE for the mild group). Thus, the specific innate and acquired allergy determinant data among individuals experiencing moderate-severe asthma is allergy information 310 that gives an indication of differential allergy severity for that group relative to other groups.

As shown in row 706, innate allergy data 306 was identified in terms of the ALOX5 non5/non5 allele genotype. Acquired allergy data 308 was also identified in terms of an eosinophil count of 390. Allergy information 310 is present in the form of a calculated and reported odds ratio of 3.647 associated with having moderate-severe asthma in ALOX5 non5/non5 individuals compared to those with ALOX5 5/5 and ALOX5 5/non5 alleles. A multivariate analysis identified family history, eosinophil count, and ALOX5 genotype as predictive of disease severity. Thus, the specific innate and acquired allergy determinant data among individuals experiencing moderate-severe asthma is allergy information 310 that gives an indication of differential allergy severity for that group relative to other groups.

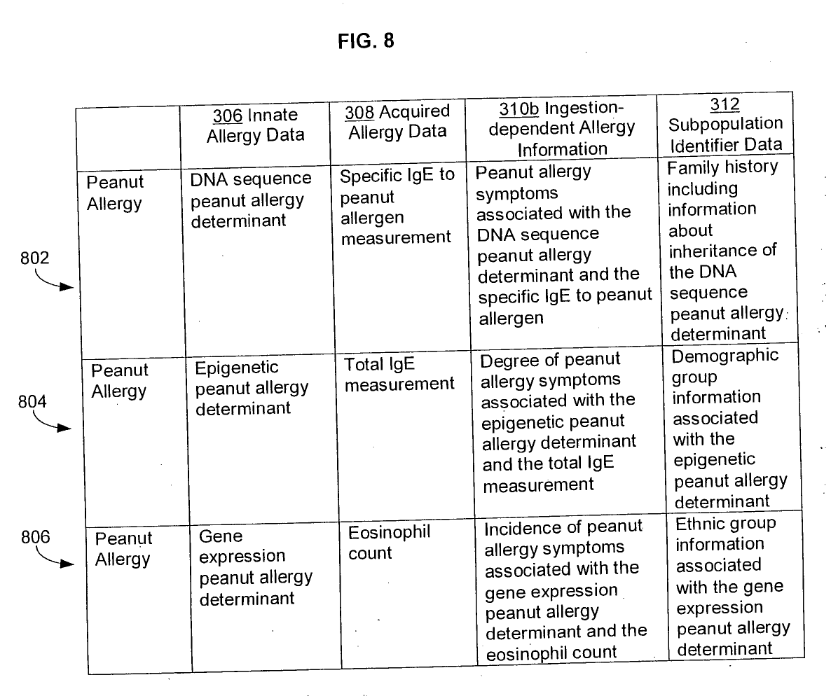

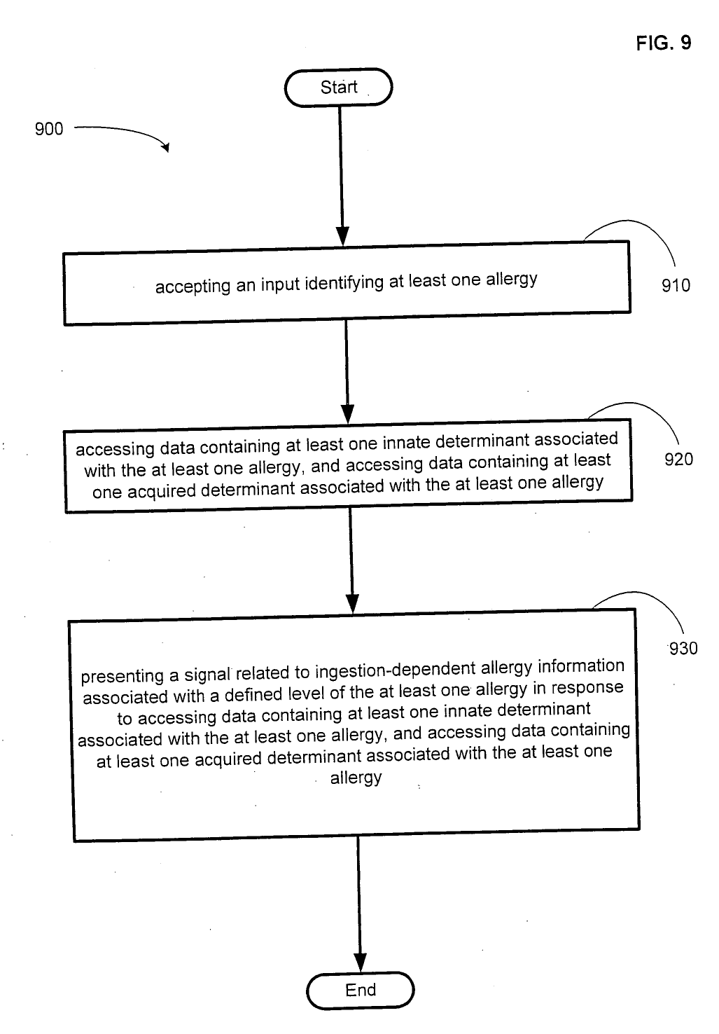

FIG. 8 illustrates hypothetical alternative embodiments of study data 106 associated with the research system 100 of FIG. 1, with specific examples of allergy study data 304.

As shown in row 802 relating to peanut allergy, innate allergy data 306 may be accessed, such as a particular DNA sequence that is associated with peanut allergy. More specifically, for example, the innate allergy data 306 may be a specific STAT6 gene sequence associated with nut allergy. See Amoli et al., “Polymorphism in the STAT6 gene encodes risk for nut allergy,” Genes &. Imm., vol. 3, pp. 220-224 (2002), which is incorporated herein in its entirety. Further, acquired allergy data 308 may be accessed, such as a measurement of specific IgE to a peanut allergen. The particular DNA sequence that is associated with peanut allergy and the measurement of specific IgE to a peanut allergen may then be linked to peanut allergy symptoms of a defined level by the allergy data analysis system 102 and/or allergy data association logic 126 and/or allergy information association logic 128. This is then an example of ingestion-dependent allergy information 310b. The allergy data analysis system 102 may then present a signal related to the ingestion-dependent allergy information 310b in response to accessing the innate and acquired allergy determinants.

As shown in row 804, also relating to peanut allergy, the innate allergy determinant may be an epigenetic peanut allergy determinant, e.g., a methylation pattern for a certain gene. The acquired allergy determinant may be a total IgE measurement associated with exposure to a peanut allergen. Ingestion-dependent allergy information 310b may be, for example, the degree of peanut allergy symptoms associated with the epigenetic peanut allergy determinant and the total IgE measurement, as determined by the allergy data analysis system 102 and/or allergy data association logic 126 and/or allergy information association logic 128. The allergy data analysis system 102 may then present a signal related to the ingestion-dependent allergy information 310b in response to accessing the innate and acquired allergy determinants.

As shown in row 806, also relating to peanut allergy, the innate allergy determinant may be a gene expression peanut allergy determinant, e.g., a certain mRNA or protein level corresponding to a certain gene. The acquired allergy determinant may be an eosinophil cell count associated with exposure to a peanut allergen. Ingestion-dependent allergy information 310b may be, for example, the incidence of peanut allergy symptoms associated with the gene expression peanut allergy determinant and the eosinophil count, as determined by the allergy data analysis system 102 and/or allergy data association logic 126 and/or allergy information association logic 128. The allergy data analysis system 102 may then present a signal related to the ingestion-dependent allergy information 310b in response to accessing the innate and acquired allergy determinants.

Further, for any of the examples of rows 802 through 806, the allergy data analysis system 102 and/or allergy data association logic 126 and/or allergy information association logic 128 may access subpopulation identifier data 312. For example, the allergy data analysis system 102 and/or allergy data association logic 126 and/or allergy information association logic 128 may access family history to associate the DNA sequence determinant with a specific portion of the family tree This may thus identify a subpopulation associated with the innate allergy data 306, and/or the acquired allergy data 308 and/or the ingestion-dependent allergy information 310b.

Alternatively, as shown in row 804, the allergy data analysis system 102 and/or allergy data association logic 126 and/or allergy information association logic 128 may access subpopulation identifier data 312 such as demographic group information associated with the epigenetic peanut allergy determinant, so as to identify a demographic subpopulation linked to the innate allergy data 306, and/or the acquired allergy data 308 and/or the ingestion-dependent allergy information 310b.

Alternatively, as shown in row 806, the allergy data analysis system 102 and/or allergy data association logic 126 and/or allergy information association logic 128 may access subpopulation identifier data 312 such as ethnic group information to make an association with the gene expression peanut allergy determinant, so as to identify an ethnic subpopulation linked to the innate allergy data 306, and/or the acquired allergy data 308 and/or the ingestion-dependent allergy information 310b.

In a case where the acquired allergy data 308 is a specific food item, subpopulation identifier data 312 may be populations following a diet that is rich in that food item (e.g., fava beans in a Mediterranean diet). Thus subpopulation identifier data 312 may be associated with acquired allergy data 308, as well as innate allergy data 306.

FIG. 9 illustrates an operational flow 900 representing example operations related to computational systems for biomedical data. In FIG. 9 and in following figures that include various examples of operational flows, discussion, and explanation may be provided with respect to the above-described examples of FIGS. 1-8, and/or with respect to other examples and contexts. However, it should be understood that the operational flows may be executed in a number of other environment and contexts, and/or in modified versions of FIGS. 1-8. Also, although the various operational flows are presented in the sequence(s) illustrated, it should be understood that the various operations may be performed in other orders than those which are illustrated, or may be performed concurrently.

After a start operation, operation 910 shows accepting an input identifying at least one allergy. The input and/or query parameter may be accepted through a user interface 132 from a researcher 104.

For example, the allergy data association logic 126 of the allergy data analysis system 102 may receive a designation of at least one allergy, such as, for example, one or more allergies for which acquired allergy data 308 is available. More specifically, this could be a defined allergy such as, for example, peanut allergy, or an allergy to a cosmetic agent such as, for example, eugenol (a.k.a., 2-methoxy-4-(2-propenyl) phenol), or eugenol derivative.

Operation 920 depicts accessing data containing at least one innate determinant associated with the at least one allergy, and accessing data containing at least one acquired determinant associated with the at least one allergy. For example, the allergy data association logic 126 and/or allergy information association logic 128 of the allergy data analysis system 102 may apply the input/query parameter to a clinical trial database to access study data associating the input with an innate allergy determinant, i.e., innate allergy data, as well as an acquired allergy determinant, i.e., acquired allergy data. For example, as discussed above, data from the Kalayci reference could be accessed to find ALOX5 genotype data and eosinophil count data associated with asthma and asthma severity.

Operation 930 illustrates presenting a signal related to ingestion-dependent allergy information associated with a defined level of the at least one allergy in response to accessing data containing at least one innate determinant associated with the at least one allergy, and accessing data containing at least one acquired determinant associated with the at least one allergy. For example, the allergy data association logic 126 and/or allergy information association logic 128 of the allergy data analysis system 102 may present a signal related to ingestion-dependent allergy information to a researcher 104 via a user interface 132. One example would be the presentation of the specific ALOX5 genotype data and eosinophil count data associated with asthma and asthma severity as the signal related to allergy information. Similarly, a specific peanut allergy innate determinant, specific peanut allergy acquired determinant, and associated defined peanut allergy level could be presented as the signal related to ingestion-dependent allergy information. Optionally, the allergy information and/or subpopulation(s) are assigned to at least one memory. For example, the allergy information and/or subpopulation(s) may be assigned to one or more of the various (types of) databases referenced above, such as the relational and/or object-oriented database(s), or to another type of memory, not explicitly mentioned.

In this regard, it should be understood that the signal may first be encoded and/or represented in digital form (i.e., as digital data), prior to the assignment to the at least one memory. For example, a digitally-encoded representation of allergy information may be stored in a local memory, or may be transmitted for storage in a remote memory.

Thus, an operation may be performed related either to a local or remote storage of the digital data, or to another type of transmission of the digital data. Of course, as discussed herein, operations also may be performed related to accessing, querying, processing, recalling, or otherwise obtaining the digital data from a memory, including, for example, receiving a transmission of the digital data from a remote memory. Accordingly, such operation(s) may involve elements including at least an operator (e.g., either human or computer) directing the operation, a transmitting computer, and/or a receiving computer, and should be understood to occur within the United States as long as at least one of these elements resides in the United States.

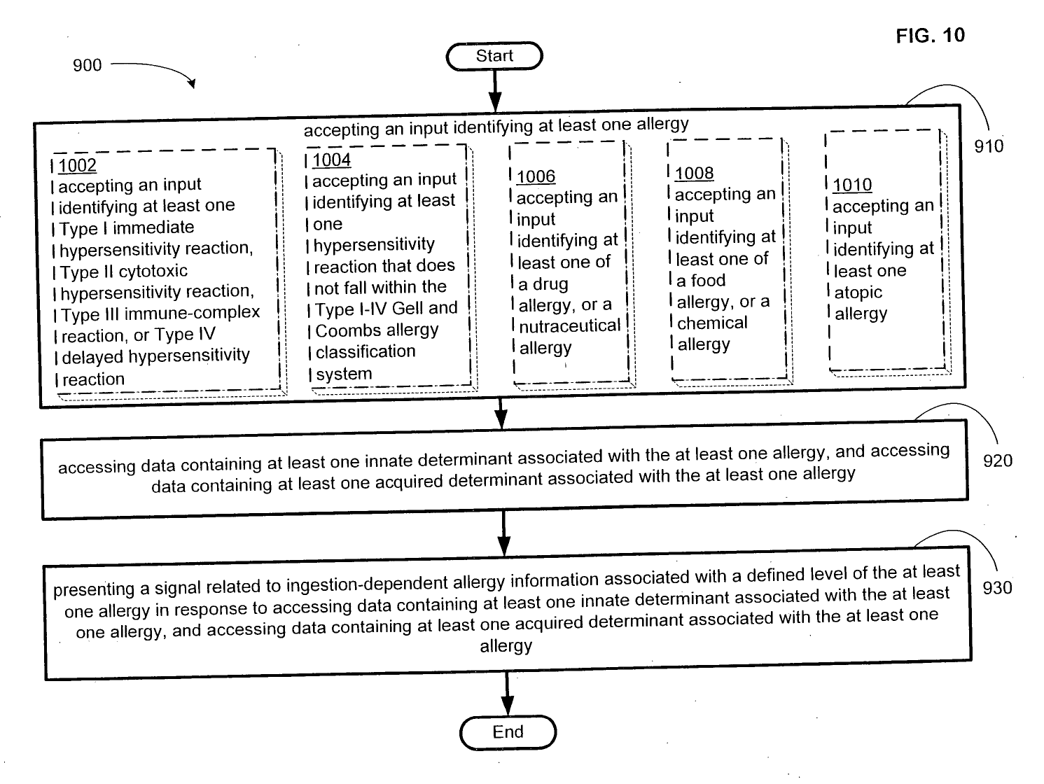

FIG. 10 illustrates alternative embodiments of the example operational flow 900 of FIG. 9. FIG. 10 illustrates example embodiments where the accepting operation 910 may include at least one additional operation. Additional operations may include operation 1002, 1004, 1006, 1008, and/or operation 1010.

Operation 1002 depicts accepting an input identifying at least one Type I immediate hypersensitivity reaction, Type II cytotoxic hypersensitivity reaction, Type III immune-complex reaction, or Type IV delayed hypersensitivity reaction. For example, the allergy data analysis system 102 and/or the allergy data association logic 126 and/or allergy information association logic 128 may accept an electronic transmission from a remote user interface 132 that identifies, for example, a type I immediate hypersensitivity reaction to latex.

Operation 1004 depicts accepting an input identifying at least one hypersensitivity reaction that does not fall within the Type I-IV Gell and Coombs allergy classification system. For example, as referenced herein, the allergy data analysis system 102 and/or the allergy data association logic 126 and/or allergy information association logic 128 may accept via a user interface 132, for example, a pseudo-allergic reaction such as that to histamine-rich foods or aspirin intolerance.

Operation 1006 depicts accepting an input identifying at least one of a drug allergy, or a nutraceutical allergy. For example, the allergy data analysis system 102 and/or the allergy data association logic 126 and/or allergy information association logic 128 may accept via a user interface 132, for example, an opioid allergy as the at least one allergy.

Operation 1008 depicts accepting an input identifying at least one of a food allergy, or a chemical allergy. For example, the allergy data analysis system 102 and/or the allergy data association logic 126 and/or allergy information association logic 128 may accept via a user interface 132, for example, a peanut allergy as the at least one allergy.

Operation 1010 depicts accepting an input identifying at least one atopic allergy. For example, the allergy data analysis system 102 and/or the allergy data association logic 126 and/or allergy information association logic 128 may accept via a user interface 132, for example, atopic dermatitis associated with egg consumption as the at least one allergy.

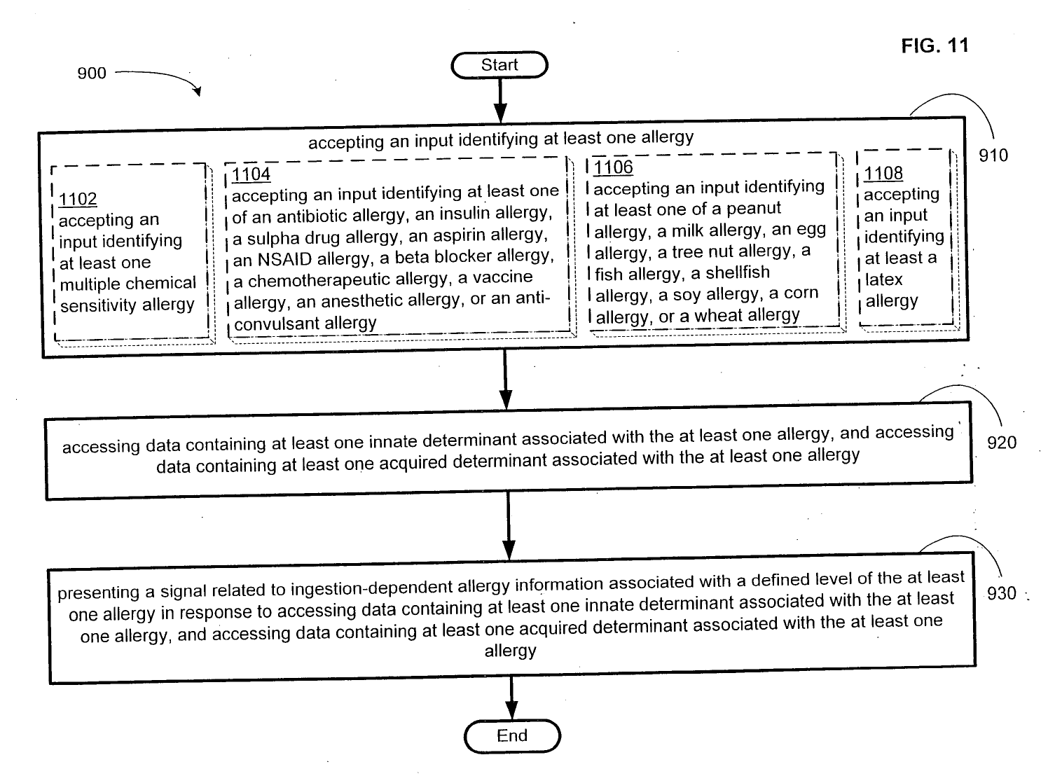

FIG. 11 illustrates alternative embodiments of the example operational flow 900 of FIG. 9. FIG. 11 illustrates example embodiments where the accepting operation 910 may include at least one additional operation. Additional operations may include operation 1102, 1104, 1106, and/or operation 1108.

Operation 1102 depicts accepting an input identifying at least one multiple chemical sensitivity allergy. For example, the allergy data analysis system 102 and/or the allergy data association logic 126 and/or allergy information association logic 128 may accept via a user interface 132, for example, sick building syndrome as the at least one allergy.

Operation 1104 depicts accepting an input identifying at least one of an antibiotic allergy, an insulin allergy, a sulpha drug allergy, an aspirin allergy, an NSAID allergy, a beta blocker allergy, a chemotherapeutic allergy, a vaccine allergy, an anesthetic allergy, or an anti-convulsant allergy. For example, the allergy data analysis system 102 and/or the allergy data association logic 126 and/or allergy information association logic 128 may accept via a user interface 132, for example, Phenobarbital allergy as the at least one allergy.

Operation 1106 depicts accepting an input identifying at least one of a peanut allergy, a milk allergy, an egg allergy, a tree nut allergy, a fish allergy, a shellfish allergy, a soy allergy, a corn allergy, or a wheat allergy. For example, the allergy data analysis system 102 and/or the allergy data association logic 126 and/or allergy information association logic 128 may accept via a user interface 132, for example, shrimp allergy as the at least one allergy.

Operation 1108 depicts accepting an input identifying at least a latex allergy. For example, the allergy data analysis system 102 and/or the allergy data association logic 126 and/or allergy information association logic 128 may accept via a user interface 132, for example, a latex glove allergy as the at least one allergy.

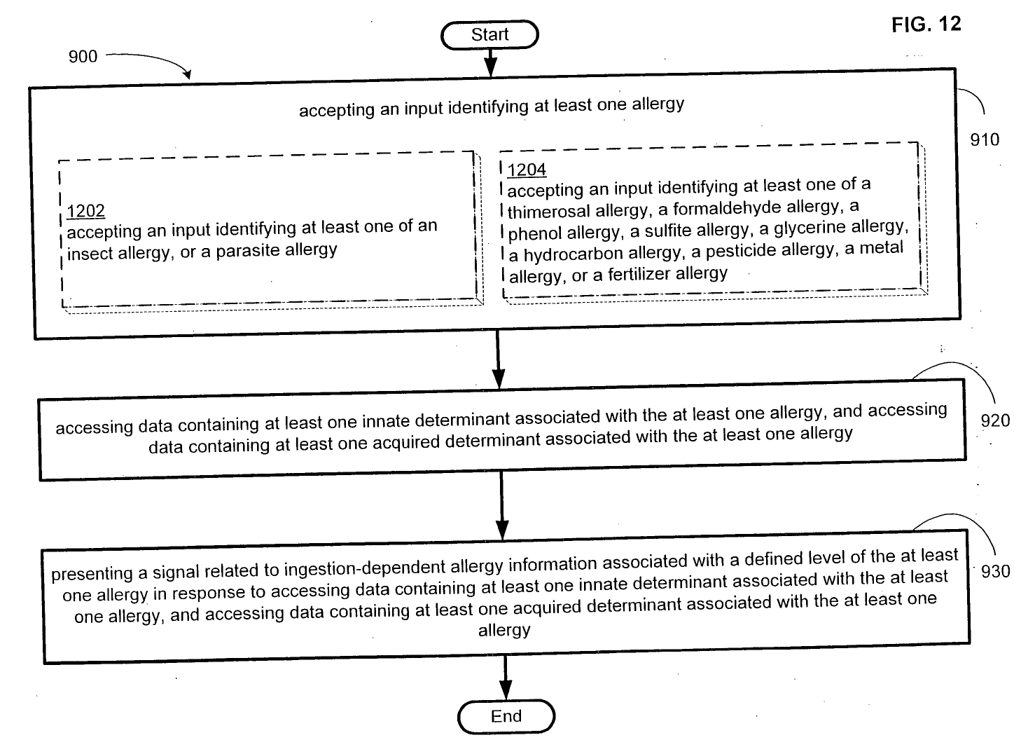

FIG. 12 illustrates alternative embodiments of the example operational flow 900 of FIG. 9. FIG. 12 illustrates example embodiments where the accepting operation 910 may include at least one additional operation. Additional operations may include operation 1202, and/or operation 1204.

Operation 1202 depicts accepting an input identifying at least one of an insect allergy, or a parasite allergy. For example, the allergy data analysis system 102 and/or the allergy data association logic 126 and/or allergy information association logic 128 may accept via a user interface 132, for example, fish parasite allergy as the at least one allergy.

Operation 1204 depicts accepting an input identifying at least one of a thimerosal allergy, a formaldehyde allergy, a phenol allergy, a sulfite allergy, a glycerine allergy, a hydrocarbon allergy, a pesticide allergy, a metal allergy, or a fertilizer allergy. For example, the allergy data analysis system 102 and/or the allergy data association logic 126 and/or allergy information association logic 128 may accept via a user interface 132, for example, nickel allergy as the at least one allergy.

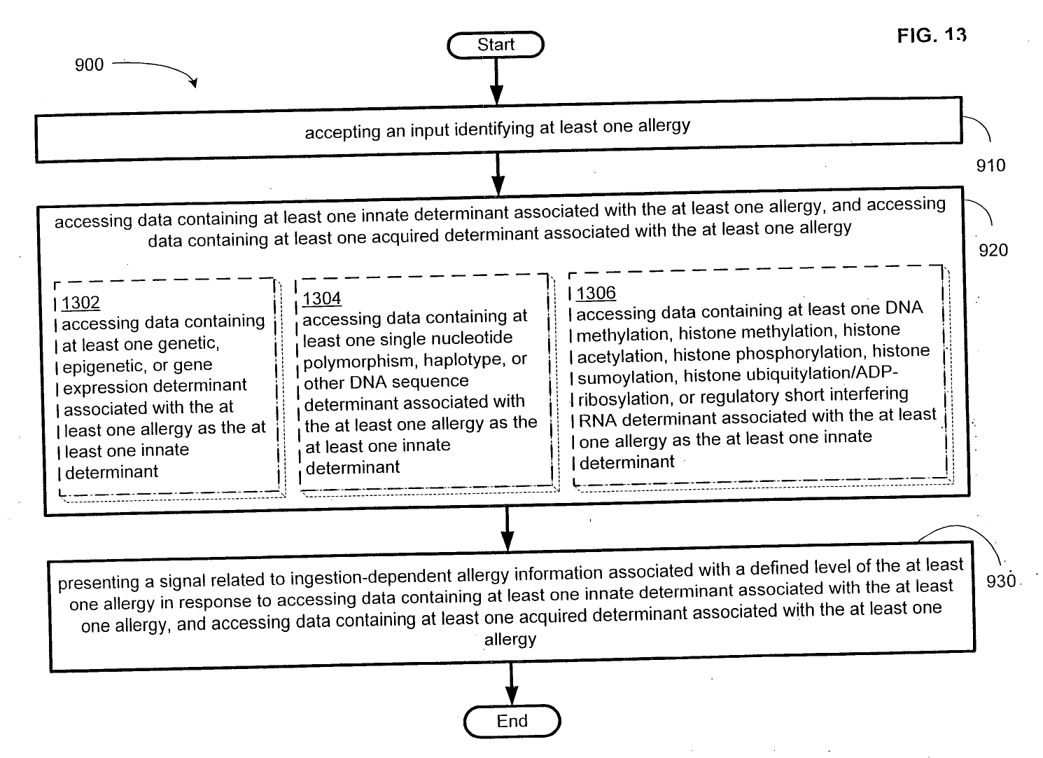

FIG. 13 illustrates alternative embodiments of the example operational flow 900 of FIG. 9. FIG. 13 illustrates example embodiments where the accessing operation 920 may include at least one additional operation. Additional operations may include operation 1302, 1304, and/or operation 1306.

Operation 1302 depicts accessing data containing at least one genetic, epigenetic, or gene expression determinant associated with the at least one allergy as the at least one innate determinant. For example, the allergy data analysis system 102 and/or the allergy data association logic 126 and/or allergy information association logic 128 may access, for example, data containing genomic DNA sequence data (e.g., ALOX5 genomic DNA sequence) as the at least one innate determinant associated with the at least one allergy.

Operation 1304 depicts accessing data containing at least one single nucleotide polymorphism, haplotype, or other DNA sequence determinant associated with the at least one allergy as the at least one innate determinant. For example, the allergy data analysis system 102 and/or the allergy data association logic 126 and/or allergy information association logic 128 may access, for example, data containing single-nucleotide polymorphisms in the ADAM33 gene (e.g., SNP ST+7) as the at least one innate determinant associated with the at least one allergy. (See Werner et al., “Asthma is associated with single-nucleotide polymorphisms in ADAM33,” Clin. Exp. Allergy, vol. 34, pp. 26-31 (2004), which is incorporated by reference herein in its entirety).

Operation 1306 depicts accessing data containing at least one DNA methylation, histone methylation, histone acetylation, histone phosphorylation, histone sumoylation, histone ubiquitylation/ADP-ribosylation, or regulatory short interfering RNA determinant associated with the at least one allergy as the at least one innate determinant. For example, the allergy data analysis system 102 and/or the allergy data association logic 126 and/or allergy information association logic 128 may access, for example, data containing histone acetylation data (e.g., changes in histone acetylation at the IL-4 and IFN-γ loci) as the at least one innate determinant associated with the at least one allergy. (See Bousquet et al., “Epigenetic inheritance of fetal genes in allergic asthma,” Allergy, vol. 59(2), pp. 138-147 (2004), which is incorporated by reference herein in its entirety).

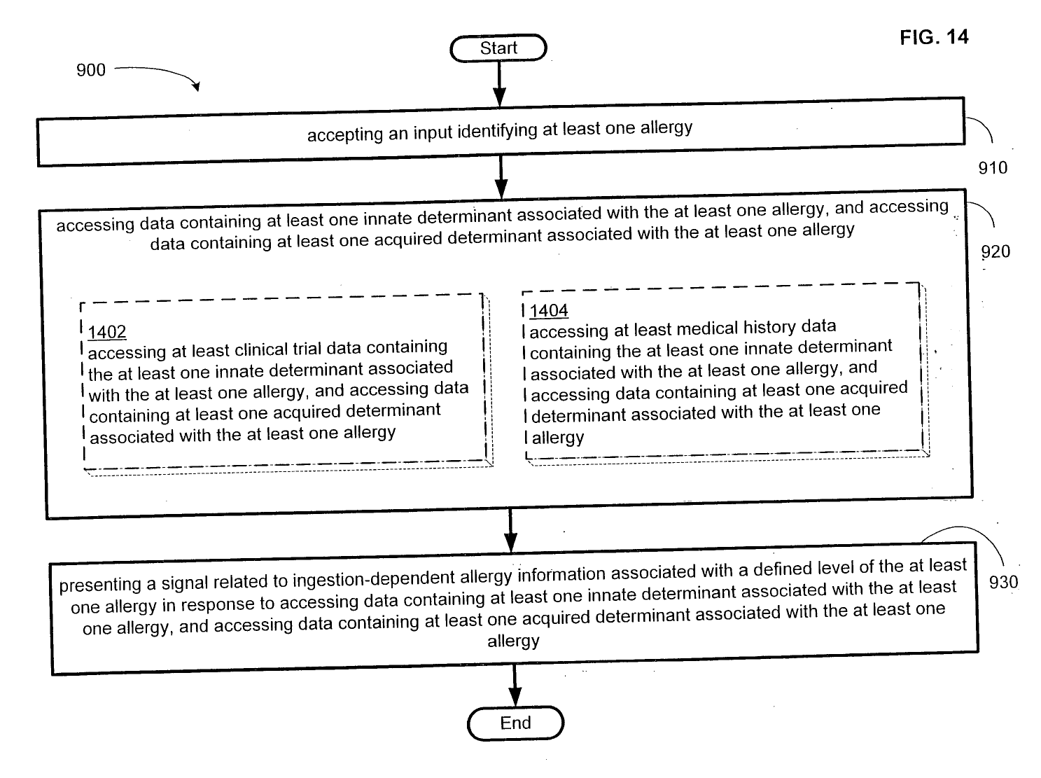

FIG. 14 illustrates alternative embodiments of the example operational flow 900 of FIG. 9. FIG. 14 illustrates example embodiments where the accessing operation 920 may include at least one additional operation. Additional operations may include operation 1402, and/or operation 1404.

Operation 1402 depicts accessing at least clinical trial data containing the at least one innate determinant associated with the at least one allergy, and accessing data containing at least one acquired determinant associated with the at least one allergy. For example, the allergy data analysis system 102 and/or the allergy data association logic 126 and/or allergy information association logic 128 may access, for example, at least data from the cross-sectional ALEX clinical trial reported in the Eder reference, discussed above, which identified CARD4/NOD1 genotypes as innate determinants associated with asthma, and accessing endotoxin exposure data associated with asthma as the at least one acquired determinant associated with the at least one allergy, as discussed above for the Eder reference.

Operation 1404 depicts accessing at least medical history data containing the at least one innate determinant associated with the at least one allergy, and accessing data containing at least one acquired determinant associated with the at least one allergy. For example, the allergy data analysis system 102 and/or the allergy data association logic 126 and/or allergy information association logic 128 may access, for example, at least any genetic information that may be present in an individual's medical history data, which can be associated with an allergy, and accessing endotoxin exposure data associated with asthma as the at least one acquired determinant associated with the at least one allergy, as discussed above for the Eder reference.

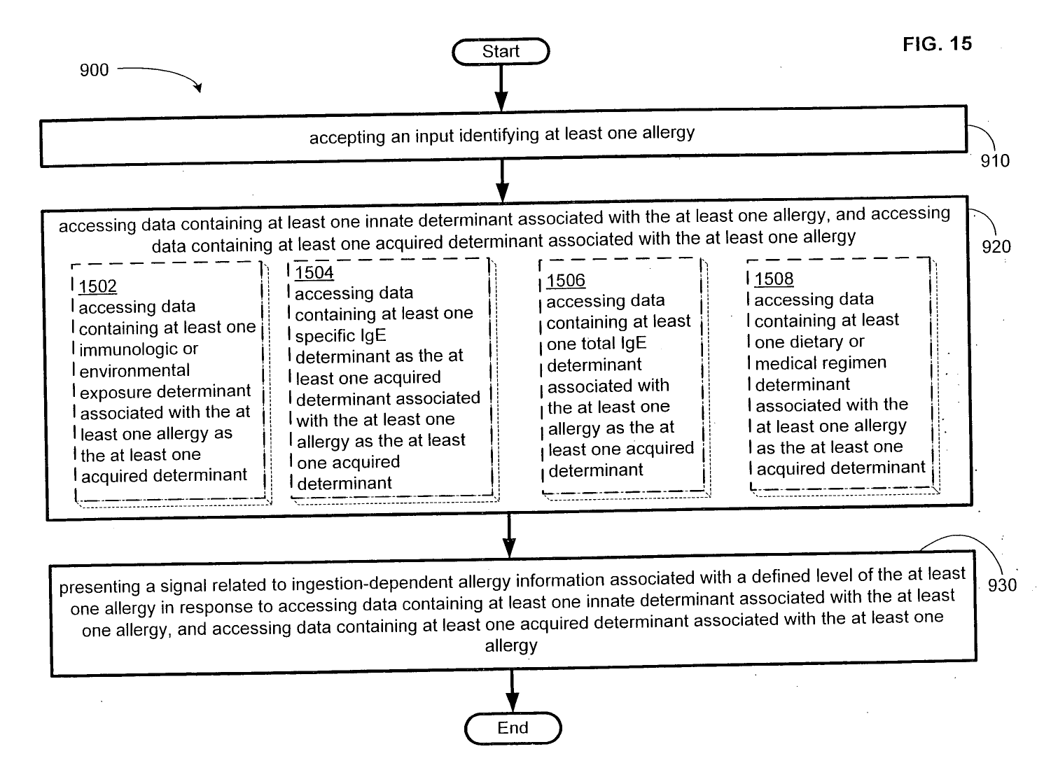

FIG. 15 illustrates alternative embodiments of the example operational flow 900 of FIG. 9. FIG. 15 illustrates example embodiments where the accessing operation 920 may include at least one additional operation. Additional operations may include operation 1502, 1504, 1506, and/or operation 1508.

Operation 1502 depicts accessing data containing at least one immunologic or environmental exposure determinant associated with the at least one allergy as the at least one acquired determinant. For example, the allergy data analysis system 102 and/or the allergy data association logic 126 and/or allergy information association logic 128 may access, for example, at least exposure to endotoxin data associated with pollen allergy as reported in the Eder reference, discussed above.

Operation 1504 depicts accessing data containing at least one specific IgE determinant as the at least one acquired determinant associated with the at least one allergy as the at least one acquired determinant. For example, the allergy data analysis system 102 and/or the allergy data association logic 126 and/or allergy information association logic 128 may access, for example, at least specific penicillin. IgE level data associated with penicillin allergy as reported in the Yang reference, discussed above.

Operation 1506 depicts accessing data containing at least one total IgE determinant associated with the at least one allergy as the at least one acquired determinant. For example, the allergy data analysis system 102 and/or the allergy data association logic 126 and/or allergy information association logic 128 may access, for example, at least total IgE level data associated with asthma as reported in the Kalayci reference, discussed above.

Operation 1508 depicts accessing data containing at least one dietary or medical regimen determinant associated with the at least one allergy as the at least one acquired determinant. For example, the allergy data analysis system 102 and/or the allergy data association logic 126 and/or allergy information association logic 128 may access, for example, peanut consumption data associated with peanut allergy as the at least one acquired determinant.

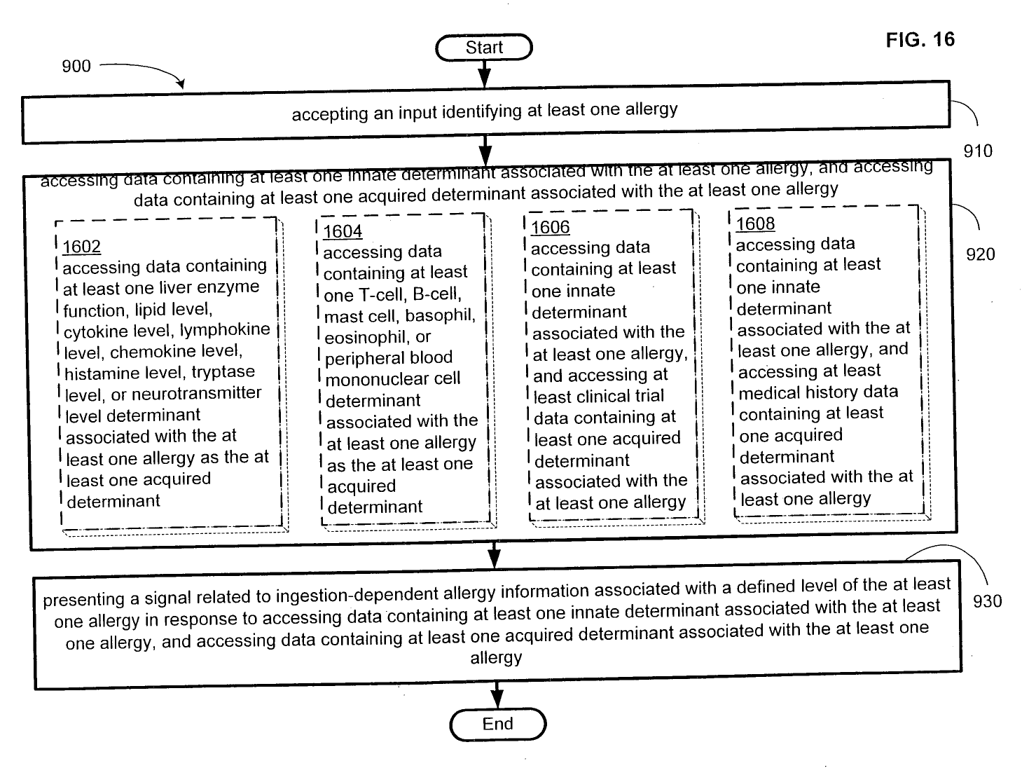

FIG. 16 illustrates alternative embodiments of the example operational flow 900 of FIG. 9. FIG. 16 illustrates example embodiments where the accessing operation 920 may include at least one additional operation. Additional operations may include operation 1602, 1604, 1606, and/or operation 1608.

Operation 1602 depicts accessing data containing at least one liver enzyme function, lipid level, cytokine level, lymphokine level, chemokine level, histamine level, tryptase level, or neurotransmitter level determinant associated with the at least one allergy as the at least one acquired determinant. For example, the allergy data analysis system 102 and/or the allergy data association logic 126 and/or allergy information association logic 128 may access, for example, at least interleukin data associated with a food allergy as the at least one acquired determinant.

Operation 1604 depicts accessing data containing at least one T-cell, B-cell, mast cell, basophil, eosinophil, or peripheral blood mononuclear cell determinant associated with the at least one allergy as the at least one acquired determinant. For example, the allergy data analysis system 102 and/or the allergy data association logic 126 and/or allergy information association logic 128 may access, for example, at least eosinophil data associated with asthma as the at least one acquired determinant, as discussed in the Kalayci reference discussed above.

Operation 1606 depicts accessing data containing at least one innate determinant associated with the at least one allergy, and accessing at least clinical trial data containing at least one acquired determinant associated with the at least one allergy. For example, the allergy data analysis system 102 and/or the allergy data association logic 126 and/or allergy information association logic 128 may access, for example, at least SNP data as innate determinant data associated with asthma, and eosinophil data from the cross-sectional ALEX study associated with asthma as the at least one acquired determinant, as discussed in the Eder reference discussed above.

Operation 1608 depicts accessing data containing at least one innate determinant associated with the at least one allergy, and accessing at least medical history data containing at least one acquired determinant associated with the at least one allergy. For example, the allergy data analysis system 102 and/or the allergy data association logic 126 and/or allergy information association logic 128 may access, for example, at least SNP data as innate determinant data associated with asthma, and parent's reports of a doctor's diagnosis of hay fever in their child associated with asthma as the at least one acquired determinant, as reported in the Eder reference discussed above.

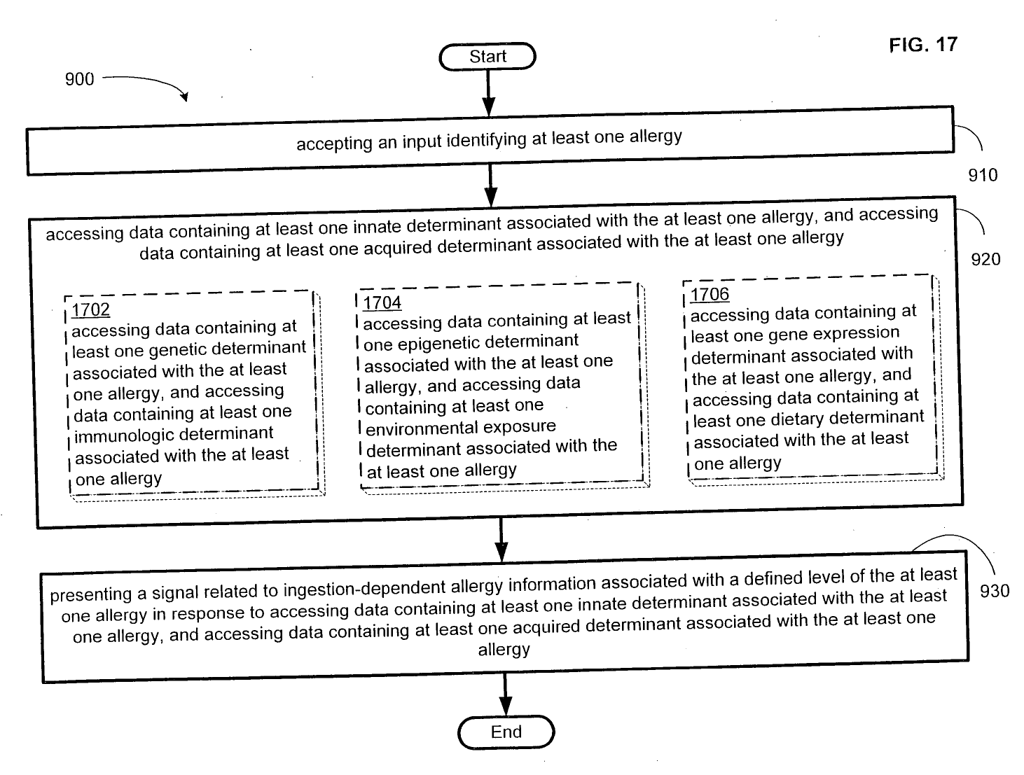

FIG. 17 illustrates alternative embodiments of the example operational flow 900 of FIG. 9. FIG. 17 illustrates example embodiments where the accessing operation 920 may include at least one additional operation. Additional operations may include operation 1702, 1704, and/or operation 1706.

Operation 1702 depicts accessing data containing at least one genetic determinant associated with the at least one allergy, and accessing data containing at least one immunologic determinant associated with the at least one allergy. For example, the allergy data analysis system 102 and/or the allergy data association logic 126 and/or allergy information association logic 128 may access, for example, at least CARD4/-21596 “TT” polymorphism data associated with pollen allergy as the at least one innate determinant associated with the at least one allergy, and specific IgE >3.5 IU/ml from farmers' children as the at least one acquired determinant associated with the at least one allergy, as reported in the Eder reference discussed above.

Operation 1704 depicts accessing data containing at least one epigenetic determinant associated with the at least one allergy, and accessing data containing at least one environmental exposure determinant associated with the at least one allergy. For example, the allergy data analysis system 102 and/or the allergy data association logic 126 and/or allergy information association logic 128 may access, for example, at least histone acetylation data associated with wheat allergy as the at least one innate determinant associated with at least one allergy, and consistent wheat consumption as the at least one acquired determinant associated with the at least one allergy.

Operation 1706 depicts accessing data containing at least one gene expression determinant associated with the at least one allergy, and accessing data containing at least one dietary determinant associated with the at least one allergy. For example, the allergy data analysis system 102 and/or the allergy data association logic 126 and/or allergy information association logic 128 may access, for example, at least mRNA expression data associated with antibiotic allergy as the at least one innate determinant associated with at least one allergy, and milk consumption as the at least one acquired determinant associated with the at least one allergy.

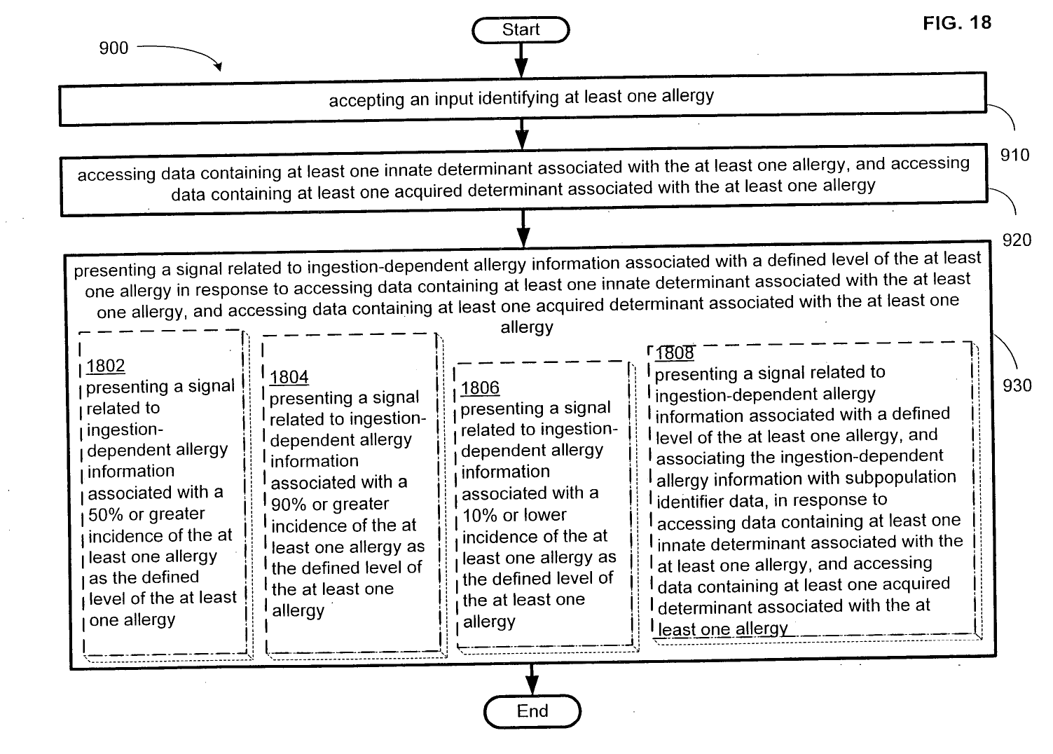

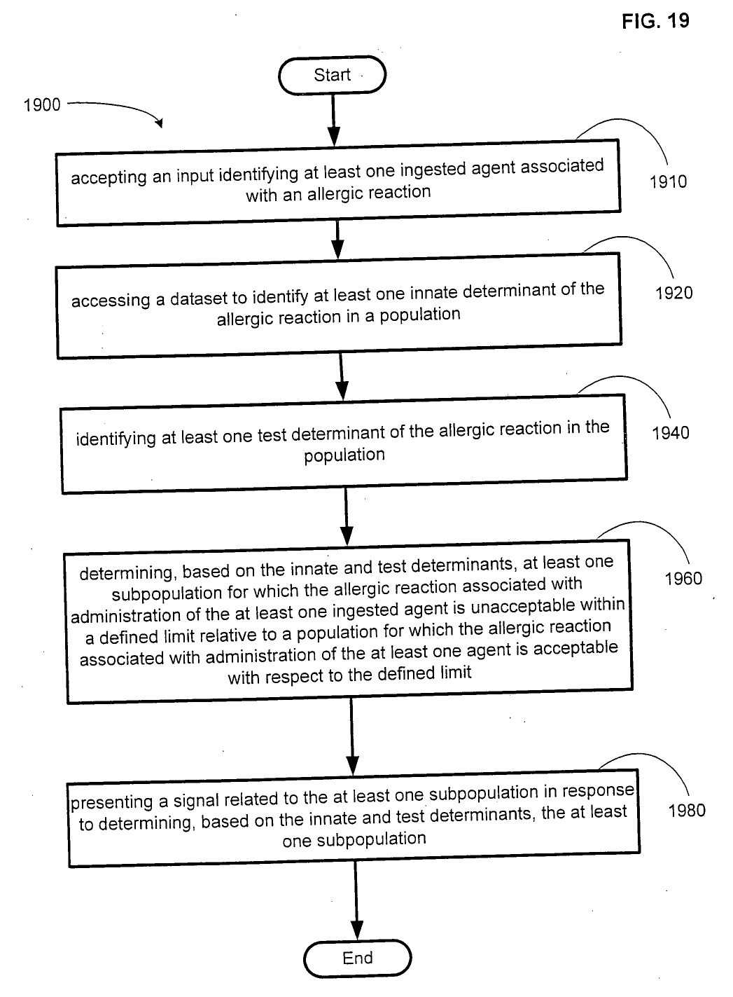

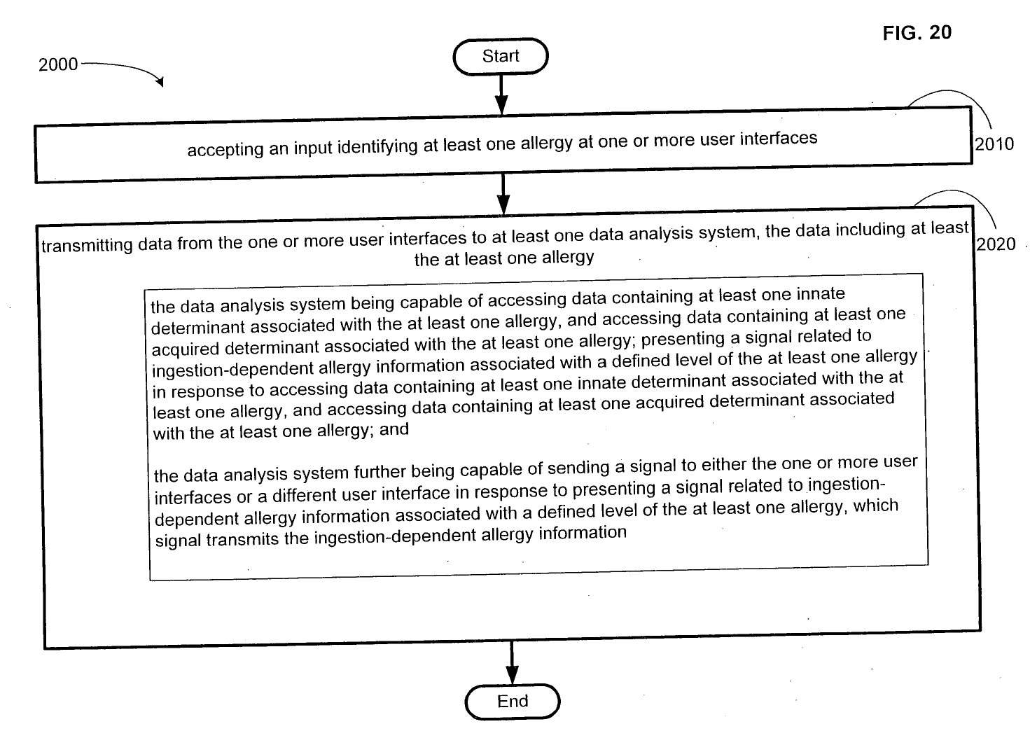

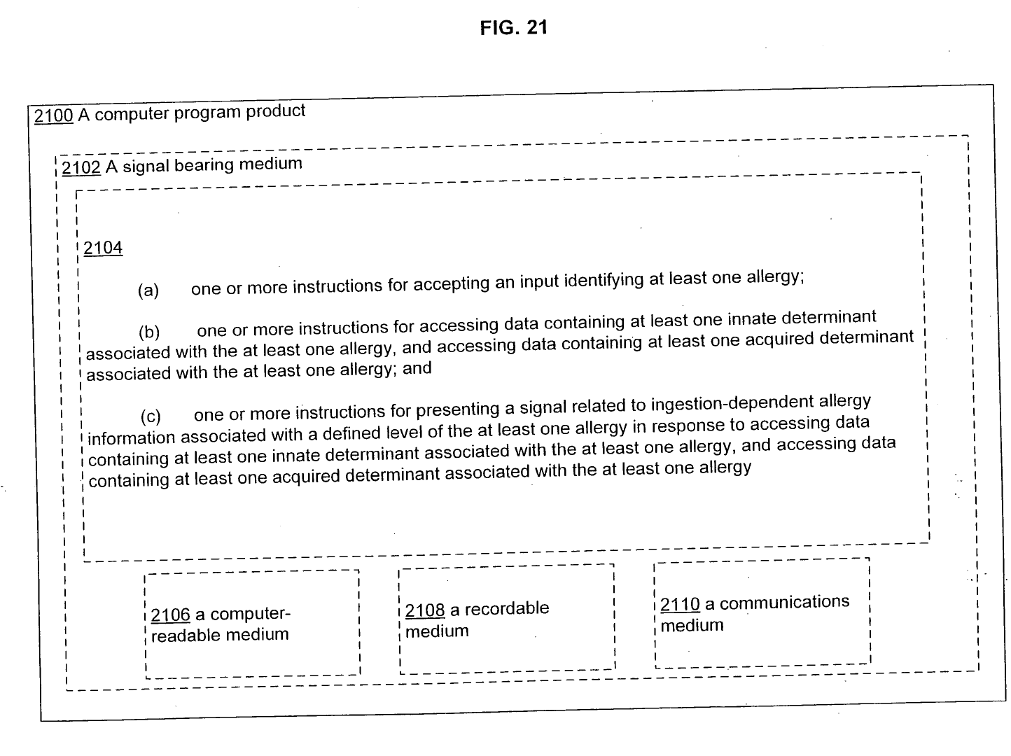

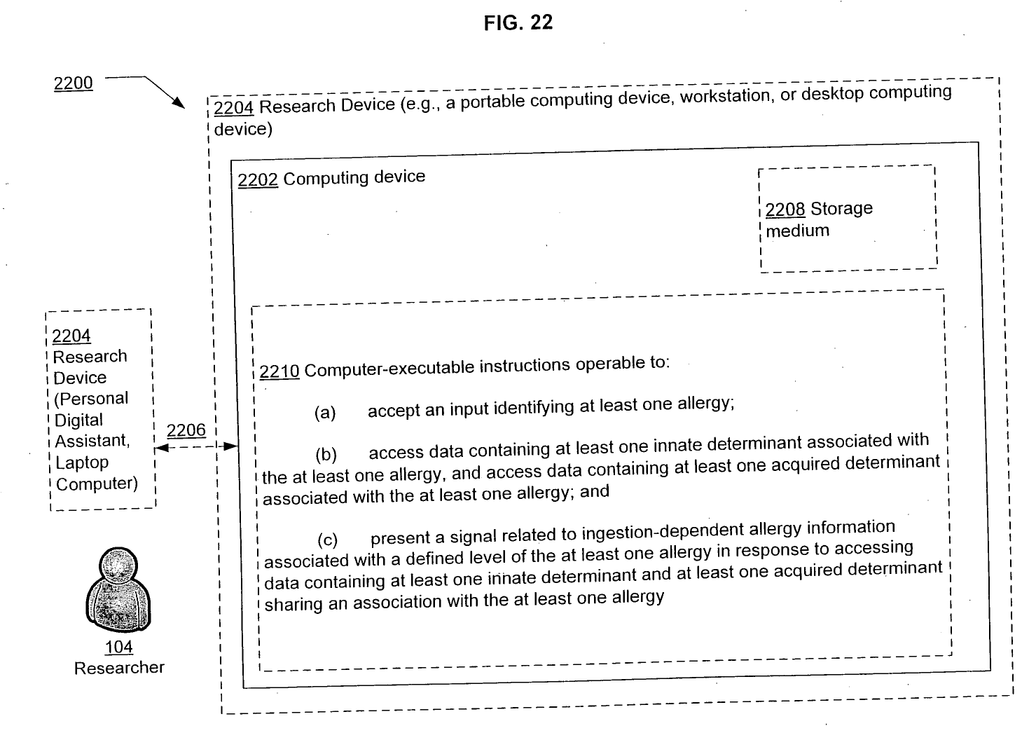

FIG. 18 illustrates alternative embodiments of the example operational flow 900 of FIG. 9. FIG. 18 illustrates example embodiments where the presenting operation 930 may include at least one additional operation. Additional operations may include operation 1802, 1804, 1806, and/or operation 1808.

Operation 1802 depicts presenting a signal related to ingestion-dependent allergy information associated with a 50% or greater incidence of the at least one allergy as the defined level of the at least one allergy. For example, the allergy data analysis system 102 and/or the allergy data association logic 126 and/or allergy information association logic 128 may present a signal related to ingestion-dependent allergy information associated with a 75% incidence of at least one allergy among individuals sharing a particular innate allergy determinant and a particular acquired allergy determinant.

Operation 1804 depicts presenting a signal related to ingestion-dependent allergy information associated with a 90% or greater incidence of the at least one allergy as the defined level of the at least one allergy. For example, the allergy data analysis system 102 and/or the allergy data association logic 126 and/or allergy information association logic 128 may present a signal related to ingestion-dependent allergy information associated with a 95% incidence of at least one allergy among individuals sharing a particular innate allergy determinant and a particular acquired allergy determinant.

Operation 1806 depicts presenting a signal related to ingestion-dependent allergy information associated with a 10% or lower incidence of the at least one allergy as the defined level of the at least one allergy. For example, the allergy data analysis system 102 and/or the allergy data association logic 126 and/or allergy information association logic 128 may present a signal related to ingestion-dependent allergy information associated with a 5% incidence of at least one allergy among individuals sharing a particular innate allergy determinant and a particular acquired allergy determinant.

Operation 1808 depicts presenting a signal related to ingestion-dependent allergy information associated with a defined level of the at least one allergy, and associating the ingestion-dependent allergy information with subpopulation identifier data, in response to accessing data containing at least one innate determinant associated with the at least one allergy, and accessing data containing at least one acquired determinant associated with the at least one allergy. For example, the allergy data analysis system 102 and/or the allergy data association logic 126 and/or allergy information association logic 128 may present a signal related to corn allergy in individuals of a certain genotype with a certain specific IgE level, associated with an 85% incidence of the corn allergy; the allergy data analysis system 102 and/or the allergy data association logic 126 and/or allergy information association logic 128 may then associate the genotype and/or specific IgE level with subpopulation identifier data, such as ethnic haplotype data that is characteristic for a clinically relevant population, e.g., individuals of Polynesian descent.

FIG. 19 illustrates an operational flow 1900 representing example operations related to computational systems for biomedical data. In FIG. 19, discussion, and explanation may be provided with respect to the above-described examples of FIGS. 1-8, and/or with respect to other examples and contexts. However, it should be understood that the operational flow may be executed in a number of other environment and contexts, and/or in modified versions of FIGS. 1-8. Also, although the operational flow is presented in the sequence illustrated, it should be understood that the various operations may be performed in other orders than those which are illustrated, or may be performed concurrently.

After a start operation, operation 1910 shows accepting an input identifying at least one ingested agent associated with an allergic reaction. The input may be accepted through a user interface 132 from a researcher 104.

For example, the allergy data association logic 126 of the allergy data analysis system 102 may receive a designation of at least one ingested allergen, such as, for example, one or more allergens for which acquired allergy data 308 is available. More specifically, this could be a known allergen such as, for example, peanuts, or a drug such as aspirin.

Operation 1920 depicts accessing a dataset to identify at least one innate determinant of the allergic reaction in a population. For example, the allergy data association logic 126 and/or allergy information association logic 128 of the allergy data analysis system 102 may access a clinical trial database to access study data associating the input agent with an innate allergy determinant, i.e., innate allergy data. For example, data could be accessed to identify genotype data associated with peanut allergy.

Operation 1940 depicts identifying at least one test determinant of the allergic reaction in the population. For example, the allergy data association logic 126 and/or allergy information association logic 128 of the allergy data analysis system 102 may access an adverse events database to find study data associating the input agent with a test determinant of the allergy (e.g., specific IgE test, skin test, food challenge test, etc.). For example, data could be accessed to identify skin test data associated with peanut allergy.

Operation 1960 depicts determining, based on the innate and test determinants, at least one subpopulation for which the allergic reaction associated with administration of the at least one ingested agent is unacceptable within a defined limit relative to a population for which the allergic reaction associated with administration of the at least one agent is acceptable with respect to the defined limit. For example, the allergy data association logic 126 and/or allergy information association logic 128 of the allergy data analysis system 102 may determine, based on a genetic determinant associated with peanut allergy and a skin test determinant of peanut allergy, a subpopulation having a severe reaction to peanuts upon exposure relative to the reaction of populations not having the genetic determinant associated with peanut allergy and the skin test determinant of peanut allergy.

Operation 1980 depicts presenting a signal related to the at least one subpopulation in response to determining, based on the innate and test determinants, the at least one subpopulation. For example, the allergy data association logic 126 and/or allergy information association logic 128 of the allergy data analysis system 102 may present the innate and test characteristics of the subpopulation having a severe reaction to peanuts upon exposure.

FIG. 20 illustrates an operational flow 2000 representing example operations related to computational systems for biomedical data. In FIG. 20, discussion, and explanation may be provided with respect to the above-described examples of FIGS. 1-8, and/or with respect to other examples and contexts. However, it should be understood that the operational flow may be executed in a number of other environment and contexts, and/or in modified versions of FIGS. 1-8. Also, although the operational flow is presented in the sequence illustrated, it should be understood that the various operations may be performed concurrently.

After a start operation, operation 2010 shows accepting an input identifying at least one allergy at one or more user interfaces. For example, the input may be accepted through a user interface 132 from a researcher 104.

For example, the allergy data association logic 126 of the allergy data analysis system 102 may receive a designation of at least one allergy at one or more user interfaces. More specifically, this could be a known allergy such as, for example, peanut allergy, or an allergy to a drug such as aspirin.

Operation 2020 depicts transmitting data from the one or more user interfaces to at least one data analysis system, the data including at least the at least one allergy, the data analysis system being capable of accessing data containing at least one innate determinant associated with the at least one allergy, and accessing data containing at least one acquired determinant associated with the at least one allergy; presenting a signal related to ingestion-dependent allergy information associated with a defined level of the at least one allergy in response to accessing data containing at least one innate determinant associated with the at least one allergy, and accessing data containing at least one acquired determinant associated with the at least one allergy; and the data analysis system further being capable of sending a signal to either the one or more user interfaces or a different user interface in response to presenting a signal related to ingestion-dependent allergy information associated with a defined level of the at least one allergy, which signal transmits the ingestion-dependent allergy information.

For example, an input from a user interface 132 from a researcher 104 may be sent to the allergy data analysis system 102, the input including, for example, chocolate allergy. The data analysis system 102 and/or allergy data association logic 126 and/or allergy information association logic 128 is capable of accessing data containing, for example, a genetic sequence associated with chocolate allergy and data containing, for example, a life history of exposure to chocolate. The data analysis system 102 and/or allergy data association logic 126 and/or allergy information association logic 128 is also capable of presenting a signal related to chocolate allergy information, including the genetic sequence associated with chocolate allergy and life history of exposure to chocolate, the chocolate allergy information associated with a significantly elevated risk of anaphylaxis upon exposure to chocolate. The data analysis system 102 and/or allergy data association logic 126 and/or allergy information association logic 128 is further capable of sending the chocolate allergy information to, for example the researcher 104 at the user interface 132.

FIG. 21 illustrates a partial view of an example computer program product 2100 that includes a computer program 2104 for executing a computer process on a computing device. An embodiment of the example computer program product 2100 is provided using a signal bearing medium 2102, and may include one or more instructions for accepting an input identifying at least one allergy; one or more instructions for accessing data containing at least one innate determinant associated with the at least one allergy, and accessing data containing at least one acquired determinant associated with the at least one allergy; and one or more instructions for presenting a signal related to ingestion-dependent allergy information associated with a defined level of the at least one allergy in response to accessing data containing at least one innate determinant associated with the at least one allergy, and accessing data containing at least one acquired determinant associated with the at least one allergy. The one or more instructions may be, for example, computer executable and/or logic-implemented instructions. In one implementation, the signal-bearing medium 2102 may include a computer-readable medium 2106. In one implementation, the signal bearing medium 2102 may include a recordable medium 2108. In one implementation, the signal bearing medium 2102 may include a communications medium 2110.

FIG. 22 illustrates an example system 2200 in which embodiments may be implemented. The system 2200 includes a computing system environment. The system 2200 also illustrates the researcher 104 using a device 2204, which is optionally shown as being in communication with a computing device 2202 by way of an optional coupling 2206. The optional coupling 2206 may represent a local, wide-area, or peer-to-peer network, or may represent a bus that is internal to a computing device (e.g., in example embodiments in which the computing device 2202 is contained in whole or in part within the device 2204). A storage medium 2208 may be any computer storage media.

The computing device 2202 includes computer-executable instructions 2210 that when executed on the computing device 2202 cause the computing device 2202 to accept an input identifying at least one allergy; access data containing at least one innate determinant associated with the at least one allergy; access data containing at least one acquired determinant associated with the at least one allergy; and present a signal related to ingestion-dependent allergy information associated with a defined level of the at least one allergy in response to accessing data containing at least one innate determinant and at least one acquired determinant sharing an association with the at least one allergy. As referenced above and as shown in FIG. 22, in some examples, the computing device 2202 may optionally be contained in whole or in part within the device 2204.

In FIG. 22, then, the system 2200 includes at least one computing device (e.g., 2202 and/or 2204). The computer-executable instructions 2210 may be executed on one or more of the at least one computing device. For example, the computing device 2202 may implement the computer-executable instructions 2210 and output a result to (and/or receive data from) the computing (research) device 2204. Since the computing device 2202 may be wholly or partially contained within the computing (research) device 2204, the research device 2204 also may be said to execute some or all of the computer-executable instructions 2210, in order to be caused to perform or implement, for example, various ones of the techniques described herein, or other techniques.

The research device 2204 may include, for example, a portable computing device, workstation, or desktop computing device. In another example embodiment, the computing device 2202 is operable to communicate with the device 2204 associated with the researcher 104 to receive information about the input from the researcher 104 for performing data access and data associations and presenting a signal(s) relating to allergy information.

Although a user or researcher 104 is shown/described herein as a single illustrated figure, those skilled in the art will appreciate that a user or researcher 104 may be representative of a human user, a robotic user (e.g., computational entity), and/or substantially any combination thereof (e.g., a user may be assisted by one or more robotic agents). In addition, a user or researcher 104, as set forth herein, although shown as a single entity may in fact be composed of two or more entities. Those skilled in the art will appreciate that, in general, the same may be said of “sender” and/or other entity-oriented terms as such terms are used herein.

One skilled in the art will recognize that the herein described components (e.g., steps), devices, and objects and the discussion accompanying them are used as examples for the sake of conceptual clarity and that various configuration modifications are within the skill of those in the art. Consequently, as used herein, the specific exemplars set forth and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

Those having skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on-one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

All of the above U.S. patents, U.S. patent application publications, U.S. patent applications, foreign patents, foreign patent applications and non-patent publications referred to in this specification and/or listed in any Application Data Sheet are incorporated herein by reference, in their entireties.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

While certain features of the described implementations have been illustrated as disclosed herein, many modifications, substitutions, changes and equivalents will now occur to those skilled in the art. It is, therefore, to be understood that the appended claims are intended to cover all such modifications and changes as fall within the true spirit of the embodiments of the invention.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Examples of such alternate orderings may include overlapping, interleaved, interrupted, reordered, incremental, preparatory, supplemental, simultaneous, reverse, or other variant orderings, unless context dictates otherwise. With respect to context, even terms like “responsive to,” “related to,” or other past-tense adjectives are generally not intended to exclude such variants, unless context dictates otherwise.

What is claimed is:

1-33. (canceled)

34. A method comprising:
accepting an input identifying at least one allergy at one or more user interfaces; and
transmitting data from the one or more user interfaces to at least one data analysis system, the data including at least the at least one allergy:
the data analysis system being capable of accessing data containing at least one innate determinant associated with the at least one allergy, and accessing data containing at least one acquired determinant associated with the at least one allergy; presenting a signal related to ingestion-dependent allergy information associated with a defined level of the at least one allergy in response to accessing data containing at least one innate determinant associated with the at least one allergy, and accessing data containing at least one acquired determinant associated with the at least one allergy; and
the data analysis system further being capable of sending a signal to either the one or more user interfaces or a different user interface in response to presenting a signal related to ingestion-dependent allergy information associated with a defined level of the at least one allergy, which signal transmits the ingestion-dependent allergy information.

35.-67. (canceled)

68. A system comprising:
means for accepting an input identifying at least one allergy at one or more user interfaces; and
means for transmitting data from the one or more user interfaces to at least one data analysis system, the data including at least the at least one allergy:
the data analysis system being capable of accessing data containing at least one innate determinant associated with the at least one allergy, and accessing data containing at least one acquired determinant associated with the at least one allergy; presenting a signal related to ingestion-dependent allergy information associated with a defined level of the at least one allergy in response to accessing data containing at least one innate determinant associated with the at least one allergy, and accessing data containing at least one acquired determinant associated with the at least one allergy; and
the data analysis system further being capable of sending a signal to either the one or more user interfaces or a different user interface in response to presenting a signal related to ingestion-dependent allergy information associated with a defined level of the at least one allergy, which signal transmits the ingestion-dependent allergy information.

69.-75. (canceled)

76. The method of claim 34 wherein the accepting an input identifying at least one allergy at one or more user interfaces comprises:
accepting an input identifying at least one ingested agent associated with at least a Type I immediate hypersensitivity reaction, a Type II cytotoxic hypersensitivity reaction, a Type III immune-complex reaction, or a Type IV delayed hypersensitivity reaction.

77. The method of claim 34 wherein the accepting an input identifying at least one allergy at one or more user interfaces comprises:
accepting an input identifying at least one ingested agent associated with a hypersensitivity reaction that does not fall within the Type I-IV Gell and Coombs allergy classification system.

78. The method of claim 34 wherein the accepting an input identifying at least one allergy at one or more user interfaces comprises:
accepting an input identifying at least one ingested agent associated with at least one of a drug allergy or a nutraceutical allergy.

79. The method of claim 34 wherein the accepting an input identifying at least one allergy at one or more user interfaces comprises:
accepting an input identifying at least one ingested agent associated with at least one of a drug allergy or a nutraceutical allergy.

80. The method of claim 34 wherein the accepting an input identifying at least one allergy at one or more user interfaces comprises:
accepting an input identifying at least one ingested agent associated with a food allergy or a chemical allergy.

81. The method of claim 34 wherein the accepting an input identifying at least one allergy at one or more user interfaces comprises:
accepting an input identifying at least one ingested agent associated with a multiple chemical sensitivity allergy.

82. The method of claim 34 wherein the accepting an input identifying at least one allergy at one or more user interfaces comprises:
accepting an input identifying at least one ingested agent associated with at least one of an antibiotic allergy, an insulin allergy, a sulpha drug allergy, an aspirin allergy, an NSAID allergy, a beta blocker allergy, a chemotherapeutic allergy, a vaccine allergy, an anesthetic allergy, or an anti-convulsant allergy.

83. The method of claim 34 wherein the accepting an input identifying at least one allergy at one or more user interfaces comprises:
accepting an input identifying at least one ingested agent associated with at least one of a peanut allergy, a milk allergy, an egg allergy, a tree nut allergy, a fish allergy, a shellfish allergy, a soy allergy, a corn allergy, or a wheat allergy.

84. The method of claim 34 wherein the accepting an input identifying at least one allergy at one or more user interfaces comprises:
accepting an input identifying at least one ingested agent associated with at least a latex allergy.

85. The method of claim 34 wherein the accepting an input identifying at least one allergy at one or more user interfaces comprises:
accepting an input identifying at least one ingested agent associated with at least one of a thimerosal allergy, a formaldehyde allergy, a phenol allergy, a sulfite allergy, a glycerine allergy, a hydrocarbon allergy, a pesticide allergy, a metal allergy, or a fertilizer allergy.

86. The method of claim 34 wherein the transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy comprises:
transmitting data from the one or more user interfaces to at least one data analysis system, the data including at least the at least one allergy: the data analysis system being capable of accessing data containing at least one genetic, epigenetic, or gene expression determinant associated with the at least one allergy as the at least one innate determinant.

87. The method of claim 34 wherein the transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy comprises:
transmitting data from the one or more user interfaces to at least one data analysis system, the data including at least the at least one allergy: the data analysis system being capable of accessing data containing at least one single nucleotide polymorphism, haplotype, or other DNA sequence determinant associated with the at least one allergy as the at least one innate determinant.

88. The method of claim 34 wherein the transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy comprises:
transmitting data from the one or more user interfaces to at least one data analysis system, the data including at least the at least one allergy: the data analysis system being capable of accessing at least one of clinical trial data or medical history data containing the at least one innate determinant associated with the at least one allergy and containing the at least one acquired determinant associated with the at least one allergy.

89. The method of claim 34 wherein the transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy comprises:
transmitting data from the one or more user interfaces to at least one data analysis system, the data including at least the at least one allergy: the data analysis system being capable of accessing at least one specific IgE determinant of the allergic reaction as the at least one acquired determinant associated with the at least one allergy.

90. The method of claim 34 wherein the transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy comprises:
transmitting data from the one or more user interfaces to at least one data analysis system, the data including at least the at least one allergy: the data analysis system being capable of accessing at least one total IgE determinant of the allergic reaction as the at least one acquired determinant associated with the at least one allergy.

91. The method of claim 34 wherein the transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy comprises:
transmitting data from the one or more user interfaces to at least one data analysis system, the data including at least the at least one allergy: the data analysis system being capable of accessing at least one T-cell, B-cell, mast cell, basophil, eosinophil, or peripheral blood mononuclear cell determinant of the allergic reaction as the at least one acquired determinant associated with the at least one allergy.

92. The method of claim 34 wherein the transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy; presenting a signal related to ingestion-dependent allergy information associated with a defined level of the at least one allergy in response to accessing data containing at least one innate determinant associated with the at least one allergy, and accessing data containing at least one acquired determinant associated with the at least one allergy comprises:
presenting, based on the innate and test determinants, at least one ethnic subpopulation associated with a defined level of the at least one allergy in response to accessing data containing at least one innate determinant associated with the at least one allergy, and accessing data containing at least one acquired determinant associated with the at least one allergy.

93. The method of claim 34 wherein the transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy; presenting a signal related to ingestion-dependent allergy information associated with a defined level of the at least one allergy in response to accessing data containing at least one innate determinant associated with the at least one allergy, and accessing data containing at least one acquired determinant associated with the at least one allergy comprises:
presenting, based on the innate and test determinants, at least one genetic subpopulation associated with a defined level of the at least one allergy in response to accessing data containing at least one innate determinant associated with the at least one allergy, and accessing data containing at least one acquired determinant associated with the at least one allergy.

94. The method of claim 34 wherein the transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy; presenting a signal related to ingestion-dependent allergy information associated with a defined level of the at least one allergy in response to accessing data containing at least one innate determinant associated with the at least one allergy, and accessing data containing at least one acquired determinant associated with the at least one allergy comprises:
presenting, based on the innate and test determinants, at least one geographic subpopulation associated with a defined level of the at least one allergy in response to accessing data containing at least one innate determinant associated with the at least one allergy, and accessing data containing at least one acquired determinant associated with the at least one allergy.

95. The system of claim 68 wherein the means for accepting an input identifying at least one allergy at one or more user interfaces comprises:
means for accepting an input identifying at least one ingested agent associated with at least a Type I immediate hypersensitivity reaction, a Type II cytotoxic hypersensitivity reaction, a Type III immune-complex reaction, or a Type IV delayed hypersensitivity reaction.

96. The system of claim 68 wherein the means for accepting an input identifying at least one allergy at one or more user interfaces comprises:
means for accepting an input identifying at least one ingested agent associated with a hypersensitivity reaction that does not fall within the Type I-IV Gell and Coombs allergy classification system.

97. The system of claim 68 wherein the means for accepting an input identifying at least one allergy at one or more user interfaces comprises:
means for accepting an input identifying at least one ingested agent associated with at least one of a drug allergy or a nutraceutical allergy.

98. The system of claim 68 wherein the means for accepting an input identifying at least one allergy at one or more user interfaces comprises:
means for accepting an input identifying at least one ingested agent associated with at least one of a drug allergy or a nutraceutical allergy.

99. The system of claim 68 wherein the means for accepting an input identifying at least one allergy at one or more user interfaces comprises:
means for accepting an input identifying at least one ingested agent associated with a food allergy or a chemical allergy.

100. The system of claim 68 wherein the means for accepting an input identifying at least one allergy at one or more user interfaces comprises:
means for accepting an input identifying at least one ingested agent associated with a multiple chemical sensitivity allergy.

101. The system of claim 68 wherein the means for accepting an input identifying at least one allergy at one or more user interfaces comprises:
means for accepting an input identifying at least one ingested agent associated with at least one of an antibiotic allergy, an insulin allergy, a sulpha drug allergy, an aspirin allergy, an NSAID allergy, a beta blocker allergy, a chemotherapeutic allergy, a vaccine allergy, an anesthetic allergy, or an anti-convulsant allergy.

102. The system of claim 68 wherein the means for accepting an input identifying at least one allergy at one or more user interfaces comprises:
means for accepting an input identifying at least one ingested agent associated with at least one of a peanut allergy, a milk allergy, an egg allergy, a tree nut allergy, a fish allergy, a shellfish allergy, a soy allergy, a corn allergy, or a wheat allergy.

103. The system of claim 68 wherein the means for accepting an input identifying at least one allergy at one or more user interfaces comprises:
means for accepting an input identifying at least one ingested agent associated with at least a latex allergy.

104. The system of claim 68 wherein the means for accepting an input identifying at least one allergy at one or more user interfaces comprises:
means for accepting an input identifying at least one ingested agent associated with at least one of a thimerosal allergy, a formaldehyde allergy, a phenol allergy, a sulfite allergy, a glycerine allergy, a hydrocarbon allergy, a pesticide allergy, a metal allergy, or a fertilizer allergy.

105. The system of claim 68 wherein the means for transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy comprises:
means for transmitting data from the one or more user interfaces to at least one data analysis system, the data including at least the at least one allergy: the data analysis system being capable of accessing data containing at least one genetic, epigenetic, or gene expression determinant associated with the at least one allergy as the at least one innate determinant.

106. The system of claim 68 wherein the means for transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy comprises:
means for transmitting data from the one or more user interfaces to at least one data analysis system, the data including at least the at least one allergy: the data analysis system being capable of accessing data containing at least one single nucleotide polymorphism, haplotype, or other DNA sequence determinant associated with the at least one allergy as the at least one innate determinant.

107. The system of claim 68 wherein the means for transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy comprises:
means for transmitting data from the one or more user interfaces to at least one data analysis system, the data including at least the at least one allergy: the data analysis system being capable of accessing at least one of clinical trial data or medical history data containing the at least one innate determinant associated with the at least one allergy and containing the at least one acquired determinant associated with the at least one allergy.

108. The system of claim 68 wherein the means for transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy comprises:
means for transmitting data from the one or more user interfaces to at least one data analysis system, the data including at least the at least one allergy: the data analysis system being capable of accessing at least one specific IgE determinant of the allergic reaction as the at least one acquired determinant associated with the at least one allergy.

109. The system of claim 68 wherein the means for transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy comprises:
means for transmitting data from the one or more user interfaces to at least one data analysis system, the data including at least the at least one allergy: the data analysis system being capable of accessing at least one total IgE determinant of the allergic reaction as the at least one acquired determinant associated with the at least one allergy.

110. The system of claim 68 wherein the means for transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy comprises:
means for transmitting data from the one or more user interfaces to at least one data analysis system, the data including at least the at least one allergy: the data analysis system being capable of accessing at least one T-cell, B-cell, mast cell, basophil, eosinophil, or peripheral blood mononuclear cell determinant of the allergic reaction as the at least one acquired determinant associated with the at least one allergy.

111. The system of claim 68 wherein the means for transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy; presenting a signal related to ingestion-dependent allergy information associated with a defined level of the at least one allergy in response to accessing data containing at least one innate determinant associated with the at least one allergy, and accessing data containing at least one acquired determinant associated with the at least one allergy comprises:
means for presenting, based on the innate and test determinants, at least one ethnic subpopulation associated with a defined level of the at least one allergy in response to the data containing at least one innate determinant associated with the at least one allergy, and the data containing at least one acquired determinant associated with the at least one allergy.

112. The system of claim 68 wherein the means for transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy; presenting a signal related to ingestion-dependent allergy information associated with a defined level of the at least one allergy in response to accessing data containing at least one innate determinant associated with the at least one allergy, and accessing data containing at least one acquired determinant associated with the at least one allergy comprises:
means for presenting, based on the innate and test determinants, at least one genetic subpopulation associated with a defined level of the at least one allergy in response to the data containing at least one innate determinant associated with the at least one allergy, and the data containing at least one acquired determinant associated with the at least one allergy.

113. The system of claim 68 wherein the means for transmitting data from the one or more user interfaces to at least one data analysis system, the data including at least the at least one allergy: the data analysis system being capable of accessing data containing at least one innate determinant associated with the at least one allergy, and accessing data containing at least one acquired determinant associated with the at least one allergy; presenting a signal related to ingestion-dependent allergy information associated with a defined level of the at least one allergy in response to accessing data containing at least one innate determinant associated with the at least one allergy, and accessing data containing at least one acquired determinant associated with the at least one allergy comprises:
means for presenting, based on the innate and test determinants, at least one geographic subpopulation associated with a defined level of the at least one allergy in response to the data containing at least one innate determinant associated with the at least one allergy, and the data containing at least one acquired determinant associated with the at least one allergy.

114. A computer program product comprising:
a signal-bearing medium bearing
(a) one or more instructions for accepting an input identifying at least one allergy at one or more user interfaces; and
(b) one or more instructions for transmitting data from the one or more user interfaces to at least one data analysis system, the data including at least the at least one allergy:
the data analysis system being capable of accessing data containing at least one innate determinant associated with the at least one allergy, and accessing data containing at least one acquired determinant associated with the at least one allergy; presenting a signal related to ingestion-dependent allergy information associated with a defined level of the at least one allergy in response to accessing data containing at least one innate determinant associated with the at least one allergy, and accessing data containing at least one acquired determinant associated with the at least one allergy; and
the data analysis system further being capable of sending a signal to either the one or more user interfaces or a different user interface in response to presenting a signal related to ingestion-dependent allergy information associated with a defined level of the at least one allergy, which signal transmits the ingestion-dependent allergy information.

115. The computer program product of claim 114, wherein the signal-bearing medium includes a computer-readable medium.

116. The computer program product of claim 114, wherein the signal-bearing medium includes a recordable medium.

117. The computer program product of claim 114, wherein the signal-bearing medium includes a communications medium.

118. A system comprising:
a computing device; and
instructions that when executed on the computing device cause the computing device to
(a) accept an input identifying at least one allergy at one or more user interfaces; and
(b) transmit data from the one or more user interfaces to at least one data analysis system, the data including at least the at least one allergy:
the data analysis system being capable of accessing data containing at least one innate determinant associated with the at least one allergy, and accessing data containing at least one acquired determinant associated with the at least one allergy; presenting a signal related to ingestion-dependent allergy information associated with a defined level of the at least one allergy in response to accessing data containing at least one innate determinant associated with the at least one allergy, and accessing data containing at least one acquired determinant associated with the at least one allergy; and
the data analysis system further being capable of sending a signal to either the one or more user interfaces or a different user interface in response to presenting a signal related to ingestion-dependent allergy information associated with a defined level of the at least one allergy, which signal transmits the ingestion-dependent allergy information.

119. The system of claim 118 wherein the computing device comprises:
one or more of a personal digital assistant (PDA), a laptop computer, a tablet personal computer, a networked computer, a computing system comprised of a cluster of processors, a computing system comprised of a cluster of servers, a workstation computer, and/or a desktop computer.

120. The system of claim 118 wherein the computing device is operable to
(a) receive information regarding the at least one allergy;
(b) receive information regarding the at least one innate determinant associated with the at least one allergy and the at least one acquired determinant associated with the at least one allergy; and
(c) present the ingestion-dependent allergy information from at least one memory.
